(19) United States
(12) Patent Application Publication
(10) Pub. No.: US 2018/0278361 A1
(43) Pub. Date: Sep. 27, 2018

(54) OPTICAL TRANSMISSION APPARATUS AND OPTICAL TRANSMISSION METHOD

(71) Applicant: FUJITSU LIMITED, Kawasaki-shi (JP)

(72) Inventor: Masao Nakata, Kawasaki (JP)

(73) Assignee: FUJITSU LIMITED, Kawasaki-shi (JP)

(21) Appl. No.: 15/896,865

(22) Filed: Feb. 14, 2018

(30) Foreign Application Priority Data
Mar. 27, 2017 (JP) 2017-060403

(51) Int. Cl. H04J 14/02

(52) U.S. Cl. CPC H04J 14/0212; H04J 14/0221

(57) ABSTRACT

An optical transmission apparatus includes a wavelength selection switch configured to: receive signal light, and attenuate power of the received signal light; an optical amplifier coupled to the wavelength selection switch and configured to optically amplify the attenuated signal light; and a processor configured to control the wavelength selection switch to attenuate power of signal light which passes a channel which is newly set by an attenuation amount based on information on light levels of spontaneous emission light generated by the optical amplifier.

### CROSS-REFERENCE TO RELATED APPLICATION

This application is based upon and claims the benefit of priority of the prior Japanese Patent Application No. 2017-60403, filed on Mar. 27, 2017, the entire contents of which are incorporated herein by reference.

### FIELD

The embodiments discussed herein are related to an optical transmission apparatus and an optical transmission method which are used in an optical communication system.

### BACKGROUND

In the optical communication system, a plurality of signal light beams having different wavelengths are subjected to wavelength multiplexing in a single optical fiber using a wavelength division multiplexing (WDM) function so that transmission light to be transmitted is obtained. An optical add/drop multiplexer (OADM) node performs insertion (Add), branching (Drop) and transmission (Thru) of the signal light beams. A network which flexibly addresses a demand of communication capacity may be formed when a plurality of OADM apparatuses are provided in the OADM node. Each of the OADM apparatuses includes a wavelength selection switch (WSS) used to select a path for each wavelength and an optical amplifier which performs optical amplification on signal light. The number of paths of the signal light may be increased by connecting a plurality of WSSes by cross-connect.

In a WDM network including a plurality of OADM nodes, when cross-connect is performed in OADM node sections and opening is successively performed, an OADM apparatus on an upstream side notifies an OADM apparatus on a downstream side of completion of opening control of the WSS on the transmission side by an optical supervisory channel (OSC) or the like. The OADM node on the downstream side stops the opening control, such as attenuation of a channel to be opened in the OADM section on the downstream side if channel opening in the OADM section on the upstream side has not been completed. If the channel opening has been completed, the channel opening control is performed on the OADM section on the downstream side. Thereafter, similarly, OADM apparatuses on the downstream side successively perform the opening control after corresponding OADM sections on the upstream side are opened.

In a case where a repeater optical amplifier (an in-line amplifier (ILA)) apparatus including an optical amplifier between OADM apparatuses is provided, the optical amplifier in the ILA apparatus has different amplification characteristics for different wavelengths. Similarly, a transmission optical fiber which transmits a WDM signal has different loss characteristics of optical power for different wavelengths. Therefore, attenuation of the WSS in a channel to be opened is gradually reduced in an OADM apparatus on an upstream side and a light level is gradually controlled to be a predetermined level so that occurrence of a case where an excessively-increased reception light level on a downstream side damages a reception apparatus is suppressed.

In general, a technique of controlling a state of an optical connector in a transmission path and an attenuation amount of an optical variable attenuator after cross-connect using spontaneous emission light is disclosed (refer to Japanese Laid-open Patent Publication No. 2006-333136, for example). An OADM node on an upstream side multiplexes two supervisory optical signals so as to obtain a WDM signal, and the WDM signal is demultiplexed by an OADM node on a downstream side. Then a communication state of a transmission optical fiber is determined using a first one of the supervisory optical signals and supervisory control is performed on an optical transmission system using a second one of the supervisory optical signals. Such a technique is disclosed (refer to Japanese Laid-open Patent Publication No. 2005-72769, for example).

However, it is assumed that opening control is simultaneously performed on all the OADM sections in parallel. In this case, as an OADM apparatus is disposed on a more downstream side, attenuation control on an upstream side is more considerably accumulated and a change amount of a WSS output level on a transmission side is increased, and accordingly, convergence into a target light level may not be quickly attained and surge of the light level is generated. Consequently, a reception light level on the downstream side is excessively increased, and therefore, the reception apparatus may be damaged.

To reduce cost, an OADM apparatus which has high flexibility for network construction and which has a large degree of freedom of selection of a path performs switching control so that light levels in different WSS channels are monitored by one optical channel monitor (OCM). In this case, when the OADM apparatus performs the gradual opening procedure described above, a period of time obtained by multiplying an OCM sweeping time by the number of optical switch connections corresponds to a channel opening control period, and therefore, the larger a distance of a transmission system becomes, the larger a period of time used to complete opening of a channel of a WDM signal becomes.

When the related art described above is used, amplification characteristics of individual channels of a WDM signal in an OADM section and loss characteristics of optical power in a transmission optical fiber may not be obtained. Accordingly, if the related art is used for opening, a reception light level on the downstream side is excessively increased, and therefore, the reception apparatus may be damaged. If a light level is gradually controlled to be a predetermined level so that the reception apparatus is not damaged, there arises a problem in that a period of time used for completion of opening becomes long as described above. Accordingly, it is preferably that the optical transmission apparatus is quickly activated.

### SUMMARY

According to an aspect of the invention, An optical transmission apparatus includes a wavelength selection switch configured to: receive signal light, and attenuate power of the received signal light; an optical amplifier coupled to the wavelength selection switch and configured to optically amplify the attenuated signal light; and a processor configured to control the wavelength selection switch to attenuate power of signal light which passes a channel which is newly set by an attenuation amount based on information on light levels of spontaneous emission light generated by the optical amplifier.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a configuration of an optical transmission system including optical transmission apparatuses according to a first embodiment;

FIG. 2 is a diagram illustrating an example of a hardware configuration of the optical transmission apparatuses according to the first embodiment;

FIGS. 3A to 3D are diagrams illustrating light level deviation of transmission light in various units included in the optical transmission system according to the first embodiment;

FIGS. 4A to 4C are diagrams illustrating light level deviation of ASE light in the various units included in the optical transmission system according to the first embodiment;

FIG. 5 is a flowchart of an example of a process of opening control in the optical transmission system according to the first embodiment;

FIG. 6 is a diagram illustrating an example of a WDM optical communication network in which the optical transmission system according to the first embodiment is employed;

FIG. 7 is a diagram illustrating an example of a configuration of an OADM apparatus according to the first embodiment;

FIG. 8 is a diagram (part 1) illustrating a problem of opening control according to a general optical transmission system;

FIG. 9 is a diagram (part 2) illustrating a problem of the opening control according to the general optical transmission system;

FIGS. 10A to 10C are diagrams illustrating a problem of the opening control according to the general optical transmission system;

FIGS. 11A to 11C are diagrams illustrating a process of the opening control of the optical transmission system according to the first embodiment;

FIG. 12 is a diagram illustrating the opening control of the optical transmission system according to the first embodiment;

FIG. 13 is a diagram illustrating an example of a configuration of an optical transmission system including optical transmission apparatuses according to a second embodiment;

FIG. 14 is a diagram illustrating an example of a configuration of an optical transmission system including optical transmission apparatuses according to a third embodiment;

FIG. 15 is a diagram illustrating an example of a configuration of an optical transmission system including optical transmission apparatuses according to a fourth embodiment;

FIG. 16 is a diagram illustrating an example of a configuration of an optical transmission system including optical transmission apparatuses according to a fifth embodiment;

FIGS. 17A to 17D are diagrams illustrating processes corresponding to light level deviation at various gains in an optical transmission system according to a sixth embodiment; and

FIGS. 18A and 18B are diagrams illustrating light levels of transmission light in the processes corresponding to the light level deviation at the various gains in the optical transmission apparatus according to the sixth embodiment.

### DESCRIPTION OF EMBODIMENTS

### First Embodiment

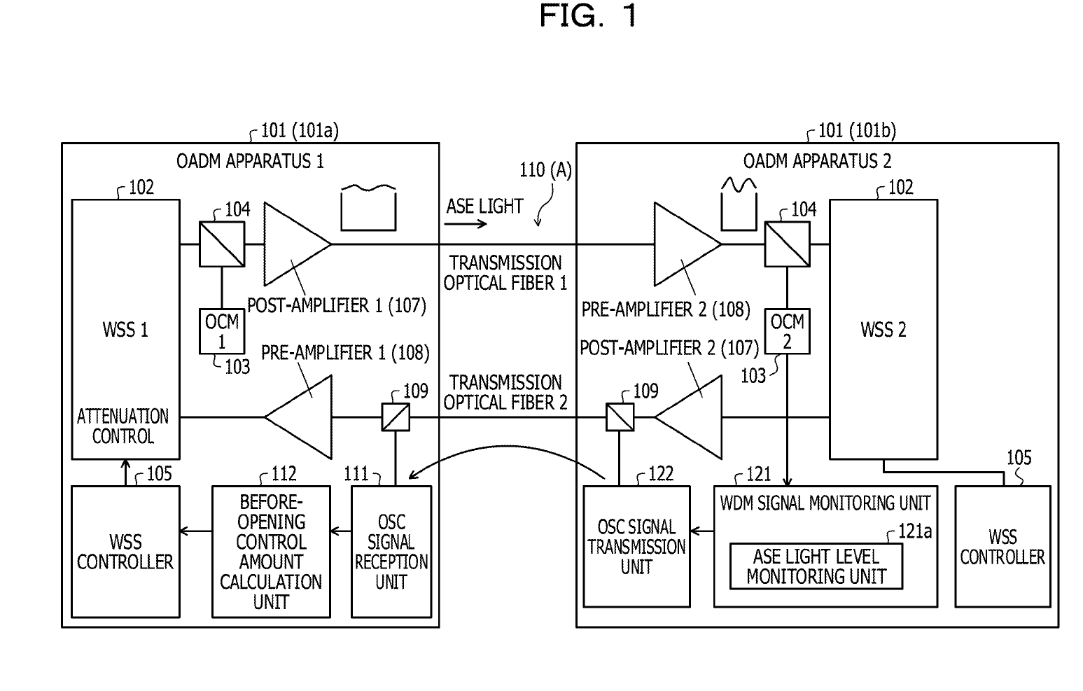

FIG. 1 is a diagram illustrating an example of a configuration of an optical transmission system including an optical transmission apparatuses according to a first embodiment. In the example of FIG. 1, configuration examples of two OADM apparatuses 101 (101a and 101b) are illustrated as examples of the optical transmission apparatuses which are installed adjacent to each other on a network. Each of the OADM apparatuses 101 is connected to optical transmission paths 110 (transmission optical fibers 1 and 2) which are subjected to wavelength multiplexing and performs Add and Drop of signal light on the optical transmission paths 110 of WDM signals. Opening of transmission light (a channel) in an OADM section A between the OADM apparatus 1 (101a) and the OADM apparatus 2 (101b) will now be described.

In the example of FIG. 1, a reference numeral 1 is assigned to components included in the OADM apparatus 1 (101a) on an upstream side of transmission of WDM signals, and a reference numeral 2 is assigned to components included in the OADM apparatus 2 (101b) on a downstream side. The OADM apparatus 1 (101a) transmits a WDM signal to the OADM apparatus 2 (101b) and receives an OSC signal transmitted from the OADM apparatus 2 (101b), for example. Each of the OADM apparatuses 101 (101a and 101b) includes an add/drop function unit and an amplification function unit.

Each of the OADM apparatuses 101 includes a multi-input single-output (N:1) wavelength selection unit 102, an optical channel monitor (OCM) 103, optical branching units 104 and 109, such as an optical splitter, and a WSS controller 105.

In the configuration example of FIG. 1, a wavelength selection switch (WSS) is used as the wavelength selection unit 102 and is controlled by the WSS controller 105. The WSS controller 105 outputs (transmits) signal light received by the WSS 102 to different paths selected according to wavelengths (channels).

The WSS controller 105 according to the first embodiment includes a function of an attenuation unit which attenuates power of signal light input to a port of the WSS 102 corresponding to a channel which is newly set (newly connected) and outputs the attenuated power.

The OADM apparatuses 101 includes a post-amplifier 107 on a transmission side of the WDM signal (transmission light) and a pre-amplifier 108 on a reception side as the amplification function unit. In the description below, the post-amplifier and the pre-amplifier are referred to as optical amplifiers where appropriate.

The OADM apparatus 1 (101a) includes an OSC signal reception unit 111 and a before-opening control amount calculation unit 112. The OADM apparatus 2 (101b) includes a WDM signal monitoring unit 121 and an OSC signal transmission unit 122.

The WSS 102 specifies different paths for different channels of different wavelengths of the WDM signal and controls attenuation amounts of light levels of the channels so as to output appropriate light levels. The OCM 103 monitors the light levels of the individual channels output from the WSS 102. The WSS controller 105 controls the attenuation amounts of the WSS 102 for individual paths and for individual channels. The WSS 102 changes an optical path by changing an angle of a micro-mirror between an input port and an output port, and the WSS controller 105 changes a light coupling state by generating certain shift amounts in an optical axis relative to the output port so as to obtain the certain attenuation amounts, for example.

The post-amplifier 107 collectively amplifies the light levels of the WDM signal which is to be transmitted and output in a multiplexing manner to the optical transmission path 110 using an add/drop function. The pre-amplifier 108 collectively amplifies the light levels of the received WDM signal which is attenuated by the optical transmission paths 110. Although not illustrated in FIG. 1, the post-amplifier 107 and the pre-amplifier 108 includes a post-amplification controller and a pre-amplification controller, respectively, which controls the WDM signal into a certain output.

A configuration of the OADM apparatus 2 (101b) will now be described. The WDM signal monitoring unit 121 monitors the light levels of the WDM signal transmitted from the counterpart OADM apparatus 1 (101a) relative to light levels of the individual channels monitored by the OCM 2 (103). The WDM signal monitoring unit 121 includes an ASE light level monitoring unit 121a. The ASE light level monitoring unit 121a monitors an ASE light level of a wavelength which does not include a wavelength multiplexing signal in amplified spontaneous emission light (ASE light) generated by the amplification control performed by the OADM apparatus 2 (101b) and the counterpart OADM apparatus 1 (101a).

The WDM signal monitoring unit 121 calculates level deviation information of the WDM transmission light for individual channels, and the ASE light level monitoring unit 121a individually calculates level deviation information of the ASE light for individual channels.

The OSC signal transmission unit 122 outputs an OSC signal (an OSC signal 2) which is a network monitoring signal to the optical transmission path 110 (the transmission optical fiber 2) toward the counterpart OADM apparatus 1 (101a).

A configuration of the OADM apparatus 1 (101a) will now be described. The OSC signal reception unit 111 receives an OSC signal supplied from the counterpart OADM apparatus 2 (101b). The OSC signal includes WDM transmission light level deviation information of individual channels and ASE light level deviation information which are calculated by the OADM apparatus 2 (101b) on the downstream side.

The before-opening control amount calculation unit 112 calculates a control amount before the opening of the optical transmission paths 110. The before-opening control amount calculation unit 112 calculates an attenuation amount of the WSS 102 using the ASE light level deviation information supplied from the counterpart OADM apparatus 2 (101b) and outputs the attenuation amount to the WSS controller 105.

In the configuration example of FIG. 1, the case where the WDM signal is transmitted from the OADM apparatus 1 (101a) through one of the transmission paths (the transmission optical fiber 1) is illustrated. However, the present disclosure is not limited to this and is similarly applicable to a configuration in which a WDM signal is transmitted from the OADM apparatus 2 (101b) to the OADM apparatus 1 (101a) through the other of the transmission paths (the transmission optical fiber 2). In this case, the WDM signal monitoring unit 121 and the OSC signal transmission unit 122 included in the OADM apparatus 2 (101b) illustrated in FIG. 1 are added to the OADM apparatus 1 (101a), and the OADM apparatus 1 (101a) transmits an OSC signal to the OADM apparatus 2 (101b) through the optical transmission path 110 (the transmission optical fiber 1). The OSC signal reception unit 111 and the before-opening control amount calculation unit 112 included in the OADM apparatus 1 (101a) illustrated in FIG. 1 are added to the OADM apparatus 2 (101b), and the OADM apparatus 2 (101b) receives an OSC signal through the optical transmission path 110 (the transmission optical fiber 1).

When a WDM signal is to be transmitted from the OADM apparatus 1 (101a) to the OADM apparatus 2 (101b), the before-opening control amount calculation unit 112 outputs a calculated attenuation amount to the WSS controller 105. The WSS controller 105 controls the WSS 1 (102) so that the attenuation amount output from the before-opening control amount calculation unit 112 is attained.

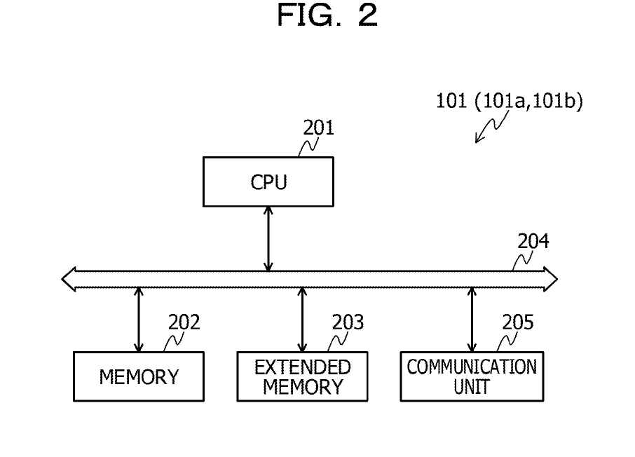

FIG. 2 is a diagram illustrating an example of a hardware configuration of the optical transmission apparatuses according to the first embodiment. Data processing performed by each of the OADM apparatuses 101 (the OADM apparatuses 1 and 2) illustrated in FIG. 1 may be realized when a central processing unit (CPU) 201 serving as a controller reads and executes a program stored in a memory 202. In this case, the CPU 201 uses the memory 202 as a work area. Examples of the memory 202 include a read only memory (ROM), a random access memory (RAM), and a flash ROM. An extended memory 203, such as an HDD, may be used as a data storage region or the like. A reference numeral 204 indicates a bus.

The CPU 201 included in the OADM apparatus 101 (the OADM apparatus 1 (101a)) illustrated in FIG. 1 integrally controls the units of the OADM apparatus 101 so as to perform signal processing on a WDM signal and controls an attenuation amount before opening. Specifically, the CPU 201 performs functions of the WSS controller 105 and the before-opening control amount calculation unit 112 illustrated in FIG. 1.

The CPU 201 included in the OADM apparatus 101 (the OADM apparatus 2 (101b)) illustrated in FIG. 1 integrally controls the units of the OADM apparatus 101 so as to perform signal processing on a WDM signal. The CPU 201 performs information processing for control of an attenuation amount before opening to be performed by the OADM apparatus 1 (101a) and transmits information to the OADM apparatus 101a. Specifically, the CPU 201 performs a process corresponding to the function of the WDM signal monitoring unit 121 illustrated in FIG. 1.

A communication unit 205 illustrated in FIG. 2 includes the WSS 102, the optical branching units 104 and 109, the post-amplifier 107, and the pre-amplifier 108 illustrated in FIG. 1 which are functions associated with transmission and reception of a WDM signal.

On a transmission path from the OADM apparatus 1 (101a) to the OADM apparatus 2 (101b), the transmission optical fiber 1, the post-amplifier 1 (107) of the OADM apparatus 1 (101a), and the pre-amplifier 2 (108) of the OADM apparatus 2 (101b) are disposed. Transmission light level deviation for wavelengths is generated in a WDM signal when the WDM signal is transmitted through the units on the transmission path.

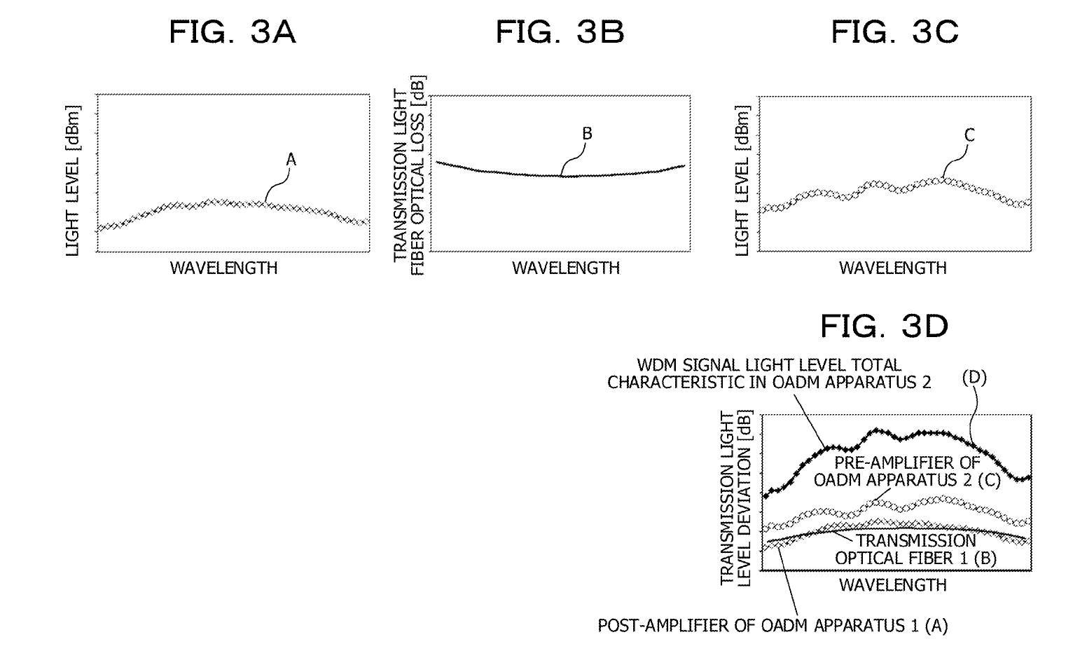

FIGS. 3A to 3D are diagrams illustrating light level deviation of transmission light in the various units included in the optical transmission system according to the first embodiment. Axes of abscissae in FIGS. 3A to 3D denote a wavelength. FIG. 3A illustrates a light level A (an axis of ordinates) of the WDM signal in the post-amplifier 1 (107) of the OADM apparatus 1 (101a). FIG. 3B illustrates an optical loss characteristic B (an axis of ordinates) in the transmission optical fiber 1 (110) used to transmit the WDM signal. FIG. 3C illustrates a light level C (an axis of ordinates) of the WDM signal received by the pre-amplifier 2 (108) of the OADM apparatus 2 (101b). As illustrated in FIGS. 3A to 3C, transmission light level deviation is generated relative to a wavelength between the optical amplifiers 107 and 108 and the optical transmission path 110 in which the WDM signal is transmitted. Transmission light level deviation is generated in the WDM signal output from the OADM apparatus 1 (101a) relative to a wavelength in the OADM apparatus 2 (101b).

FIG. 3D illustrates a wavelength characteristic D in transmission light level deviation (an axis of ordinates) of the WDM signal transmitted from the OADM apparatus 1 (101a) to the OADM apparatus 2 (101b). The wavelength characteristic D is obtained by adding the wavelength characteristics A to C of the optical amplifiers 107 and 108 and the optical transmission path 1 (110) in which the WDM signal is transmitted to one another.

Here, the post-amplifier 1 (107) included in the OADM apparatus 1 (101a) and the pre-amplifier 2 (108) included in the OADM apparatus 2 (101b) generate ASE light in accordance with amplification control performed on the WDM signal. Level deviation relative to a wavelength of the ASE light has correlation with transmission light level deviation relative to the wavelength of the WDM signal in the optical amplifiers 107 and 108.

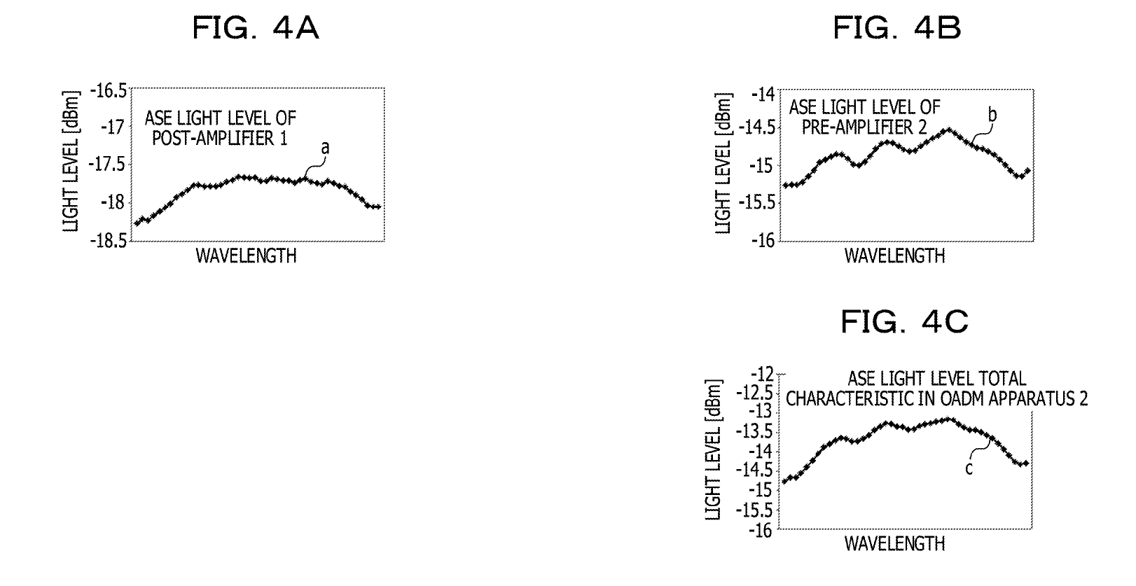

FIGS. 4A to 4C are diagrams illustrating light level deviation of ASE light in the various units included in the optical transmission system according to the first embodiment. Axes of abscissae in FIGS. 4A to 4C denote a wavelength and axes of ordinates denote a light level. FIG. 4A illustrates a light level a (an axis of ordinates) of the ASE light in the post-amplifier 1 (107) of the OADM apparatus 1 (101a). FIG. 4B illustrates a light level b (an axis of ordinates) of the ASE light received by the pre-amplifier 2 (108) of the OADM apparatus 2 (101b).

As illustrated in FIG. 4C, a wavelength characteristic c of transmission light level deviation of the ASE light transmitted from the OADM apparatus 1 (101a) to the OADM apparatus 2 (101b) is obtained by adding the wavelength characteristics of the optical amplifiers 107 and 108 and the transmission optical fiber 1 (110) in which the ASE light is transmitted to one another. Here, the optical loss deviation of the WDM signal and the optical loss deviation of the ASE light relative to the wavelength of the transmission light fiber in the transmission optical fiber 1 (110) are equal to each other.

The light level deviation characteristics of the light levels A, C, and D of the WDM signal illustrated in FIGS. 3A, 3C, and 3D and those of the light levels a to c of the ASE light illustrated in FIGS. 4A to 4C relative to the wavelength are similar to each other. Since the light level deviation characteristics are strongly associated with the wavelengths of the WDM signal and the wavelengths of the ASE light in the amplifiers 107 and 108, transmission light level deviation of the WDM signal may be obtained from transmission light level deviation of the ASE light.

The transmission light level deviation of the ASE light which reaches the OADM apparatus 2 (101b) from the OADM apparatus 1 (101a) and the transmission light level deviation of the WDM signal which reaches the OADM apparatus 2 (101b) from the OADM apparatus 1 (101a) are obtained by adding level deviations of the optical amplifiers 107 and 108 and the transmission optical fiber (110) relative to wavelengths. Since the correlation between the level deviation characteristics of the WDM signal and the level deviation characteristics of the ASE light relative to the wavelengths in the optical amplifiers 107 and 108 are used, the transmission light level deviation of the WDM signal may be obtained from the transmission light level deviation of the ASE light which reaches the OADM apparatus 2 (101b) from the OADM apparatus 1 (101a).

According to the first embodiment, the transmission light level deviation of the WDM signal relative to the wavelength in the OADM section between the OADM apparatus 1 (101a) to the OADM apparatus 2 (101b) is obtained before opening for the WDM signal. Since the transmission light level deviation is correlated with the transmission light level deviation of the WDM signal, the transmission light level deviation of the WDM signal is obtained from the transmission light level deviation of the ASE light. Thereafter, an ASE light level in a wavelength of unopened channel of the WDM signal is measured so that the transmission light level deviation of the ASE light relative to the wavelength is detected. In this way, the transmission light level deviation characteristic of the WDM signal relative to the wavelength is obtained before the channel is opened.

Using the transmission light level deviation of the WDM signal relative to the wavelength obtained from the ASE light, an attenuation amount of the WSS1 (102) of the OADM apparatus 1 (101a), that is, an output light level of the WSS1 (102) is controlled. By this, the transmission light level deviation characteristic may be recognized before the channel of the WDM signal is opened, and light levels to be output from the WSS1 (102) of the OADM apparatus 1 (101a) to the post-amplifier 1 (107) for individual channels may be quickly controlled to target attenuation amounts.

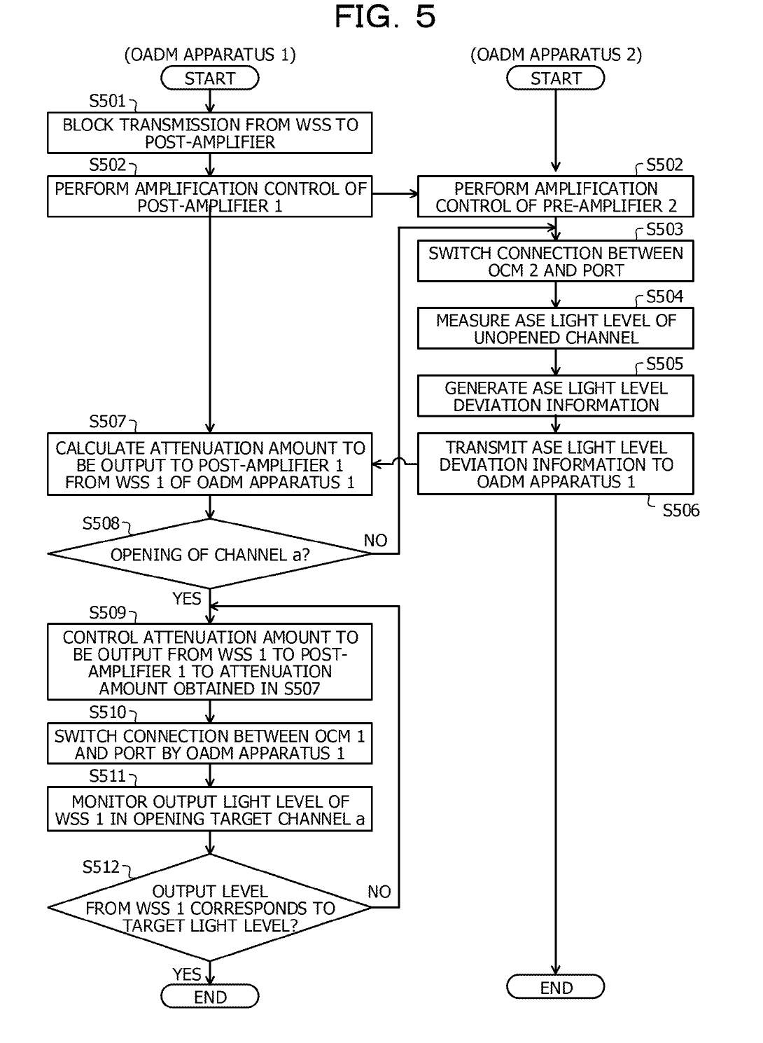

FIG. 5 is a flowchart of an example of a process of opening control performed in the optical transmission system according to the first embodiment. An example of a process of opening control performed on an unopened channel by the CPUs 201 included in the OADM apparatuses 1 and 2 (101a and 101b) in the optical transmission system illustrated in FIG. 1 will be described.

First, the CPU 201 in the OADM apparatus 1 (101a) blocks transmission from the WSS 1 (102) to the post-amplifier 1 (107) in an unopened channel (S501). For example, the WSS controller 105 sets a large attenuation amount 30 dB to the WSS 1 (102).

Thereafter, the OADM apparatus 1 (101a) performs amplification control of the post-amplifier 1 (107) and the OADM apparatus 2 (101b) performs amplification control of the pre-amplifier 2 (108) (S502).

The CPU 201 of the OADM apparatus 2 (101b) performs switching control so that ports of the OADM apparatus 2 (101b) are successively connected to the OCM 2 (103) (S503). The CPU 201 (the ASE light level monitoring unit 121a) of the OADM apparatus 2 (101b) measures an ASE light level of the unopened channel (the channel a) of the OADM apparatus 2 (101b) when connection of the pre-amplifier 2 (108) and the connection of the OCM 2 (103) match each other (S504). By this, the ASE light level generated due to the amplification control performed on the optical amplifiers 107 and 108 is measured.

The CPU 201 (the ASE light level monitoring unit 121a) of the OADM apparatus 2 (101b) generates information on ASE light level deviation of the unopened channel (S505). The CPU 201 (the ASE light level monitoring unit 121a) transmits the generated information on the ASE light level deviation from the OADM apparatus 2 (101b) through the optical transmission fiber 2 (110) to the OADM apparatus 1 (101a) using an OSC signal (S506).

Thereafter, the CPU 201 (the before-opening control amount calculation unit 112) of the OADM apparatus 1 (101a) calculates an attenuation amount of transmission light output from the WSS 1 (102) based on the information on the ASE light level deviation supplied from the OADM apparatus 2 (101b) (S507).

Then the CPU 201 of the OADM apparatus 1 (101a) determines whether a certain one (the channel a) of the unopened channels is to be opened (S508). When the determination is affirmative (S508: Yes), the process proceeds to step S509, and otherwise (S508: No), the process returns to step S503.

The CPU 201 (the WSS controller 105) controls the transmission light of the channel a to be output from the WSS 1 (102) of the OADM apparatus 1 (101a) to the post-amplifier 1 (107) so as to obtain the attenuation amount calculated in step S507 (S509).

The CPU 201 of the OADM apparatus 1 (101a) performs switching control so that ports of the OADM apparatus 1 (101a) are successively connected to the OCM 2 (103) (S510). Thereafter, the CPU 201 monitors an output light level of the WSS 1 (102) in the channel a which is a target of opening when output of the WSS 1 (102) and the connection of the OCM 1 (103) match each other (S511).

The CPU 201 of the OADM apparatus 1 (101a) determines whether an output level of the WSS 1 (102) of the channel a has reached a target light level (S512). When the determination is negative (S512: No), the CPU 201 holds an attenuation amount of the WSS 1 (102) of the channel a and returns to the process in step S509. On the other hand, when the determination is affirmative (S512: Yes), the control described above is terminated.

The channel opening illustrated with reference to FIG. 5 will be described in detail with reference to the optical transmission system illustrated in FIG. 1. An ASE light level P_ASE(i) of the ASE light which reaches the OADM apparatus 2 (101b) from the OADM apparatus 1 (101a) in a wavelength of an unopened channel i of the WDM signal is measured by the OCM 2 (103) of the OADM apparatus 2 (101b) (S504). The CPU 201 (the ASE light level monitoring unit 121a) of the OADM apparatus 2 (101b) obtains ASE light level deviation information ΔP_ASE(i) in accordance with Expression (1) below (S505). Here, the ASE light level deviation information ΔP_ASE(i) is obtained using the number m of unopened channels, a total amount P_ASE_TOTAL of the ASE light level, and an average level P_ASE_AVG of the ASE light.

$${P}_{—} {ASE}_{—} AVG = {\sum }_{i = 1}^{m} {P}_{—} ASE ( i ) \text{/} m \\ Δ {P}_{—} ASE ( i ) = {P}_{—} ASE ( i ) - {P}_{—} {ASE}_{—} AVG \qquad ( 1 )$$

The ASE light level deviation information ΔP_ASE(i) of the individual channels calculated by the ASE light level monitoring unit 121a is transmitted from the OSC signal transmission unit 122 of the OADM apparatus 2 (101b) through the transmission optical fiber 2 (110) to the OADM apparatus 1 (101a). In this case, a notification indicating this transmission is transmitted to the OSC signal reception unit 111 of the OADM apparatus 1 (101a) using the OSC signal (S506). The ASE light level deviation information ΔP_ASE(i) received by the OSC signal reception unit 111 of the OADM apparatus 1 (101a) is output to the CPU 201 (the before-opening control amount calculation unit 112) of the OADM apparatus 1 (101a).

The before-opening control amount calculation unit 112 calculates attenuation amounts to be output from the WSS 1 (102) of the unopened channel to the post-amplifier 1 (107) in accordance with the ASE light level deviation information ΔP_ASE(i) (S507).

An example of the calculation of the attenuation amounts performed by the before-opening control amount calculation unit 112 will now be described. It is assumed that, in the WDM signal transmitted from the OADM apparatus 1 (101a) to the OADM apparatus 2 (101b), an input light level of the WSS 1 (102) of the unopened channel b is −10 dBm. It is further assumed that a level of light to be output from the WSS 1 (102) to the post-amplifier 1 (107) is −20 dBm. In this case, a first calculation value of an attenuation amount of the channel b to be output by the CPU 201 (the WSS controller 105) from the WSS 1 (102) to the post-amplifier 1 (107) is 10 dB similarly to the opened channel a.

In the ASE light emitted from the OADM apparatus 1 (101a) to the OADM apparatus 2 (101b), ASE light level deviation information ΔP_ASE(b) of the channel b which is monitored by the OADM apparatus 2 (101b) is transmitted to the OADM apparatus 1 (101a) using the OSC signal. The before-opening control amount calculation unit 112 of the OADM apparatus 1 (101a) calculates an attenuation amount calculation value ATT(b) of the channel b to be output from the WSS1 (102) to the post-amplifier 1 (107) in accordance with Expression (2) below.

ATT(b)=10 dB+ΔP_ASE(b)×α(b) (2)

Here, “α(b)” denotes a value determined based on control information of a post-amplifier controller (not illustrated) which controls the post-amplifier 1 (107) of the OADM apparatus 1 (101a) and control information of a pre-amplifier controller which controls the pre-amplifier 2 (108) of the OADM apparatus 2 (101b). The value α(b) is determined in accordance with amplification gains of the optical amplifiers 107 and 108 and a wavelength of the channel, for example.

In a case where the ASE light level ΔP_ASE(b) of the channel b monitored by the OADM apparatus 2 (101b) is larger than P_ASE_AVG by 1 dB, for example, the ASE light level deviation information ΔP_ASE(b) is +1 dB. In a case where α(b) obtained by the amplification gains of the pre-amplifier 2 (108) and the post-amplifier 1 (107) is 1, an attenuation calculation value of the channel b which is obtained by the before-opening control amount calculation unit 112 and which is output from the WSS 1 (102) to the post-amplifier 1 (107) is 11 dB.

Thereafter, the before-opening control amount calculation unit 112 calculates a before-connection attenuation control amount of +11 dB of the channel b using the ASE light level deviation information between the OADM apparatus 1 (101a) and the OADM apparatus 2 (101b) which is measured in advance before the opening and uses the before-connection attenuation control amount of +11 dB for the attenuation control. The transmission light level deviation of the ASE light has the correlation with the transmission light level deviation characteristic of the WDM signal transmitted from the OADM apparatus 1 (101a) to the OADM apparatus 2 (101b) as described above. Therefore, the OADM apparatus 1 (101a) may recognize a reception light level, that is, a transmission light level, of the OADM apparatus 2 (101b) on a downstream side in the unopened channel b.

The CPU 201 (the before-opening control amount calculation unit 112) calculates the attenuation amount of 11 dB of the channel b which is to be output from the WSS 1 to the post-amplifier 1 and which is an attenuation amount calculation value before opening corresponding to the transmission light level deviation characteristic. Before the channel b is opened, the CPU 201 (the WSS controller 105) performs control so as to obtain the attenuation value described above. By this, the opening is quickly performed while the transmission light level deviation characteristic is corrected without an excessive reception light level in the OADM apparatus 2 (101b) on the downstream side (S509).

According to the first embodiment, attenuation amounts based on the transmission light level deviation characteristics of the individual channels are calculated before opening for the WDM signal, and control may be quickly performed so that certain attenuation amounts are obtained in accordance with the transmission light level deviation characteristics at the time of the opening for the WDM signal.

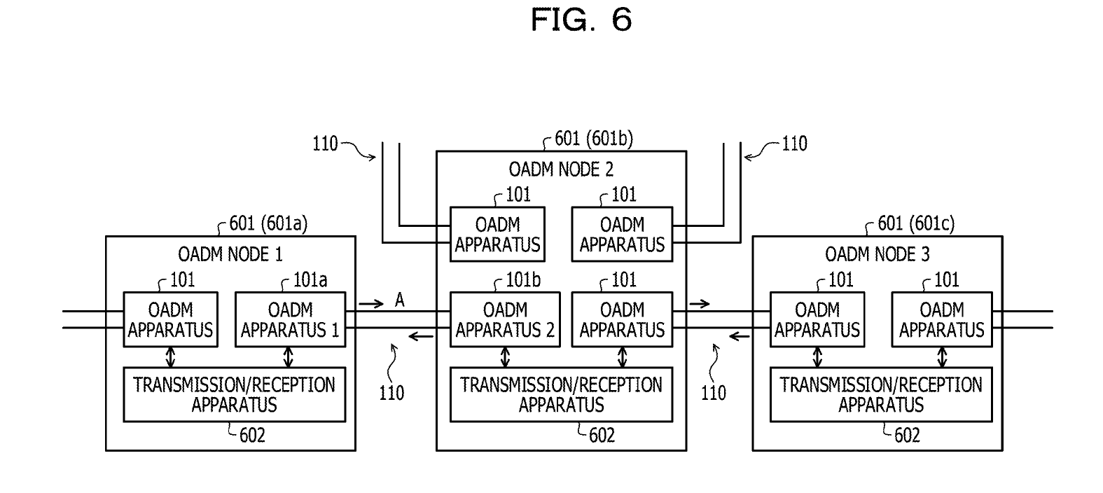

FIG. 6 is a diagram illustrating an example of a WDM optical communication network in which the optical transmission system according to the first embodiment is applicable. Since the plurality of OADM apparatuses 101 are accommodated in an OADM node 601, the WDM signal is dropped or added in a plurality of directions in the OADM node 601 so that the WDM signal is input to or output from a transmission/reception apparatus 602. In this way, a network which may flexibly cope with a demand of communication capacity may be constructed. For example, the OADM apparatus 1 (101a) described above is included in an OADM node 1 (601a), the OADM apparatus 2 (101b) is included in an OADM node 2 (601b), and an OADM section A is set between the OADM nodes 1 and 2 (601a and 601b).

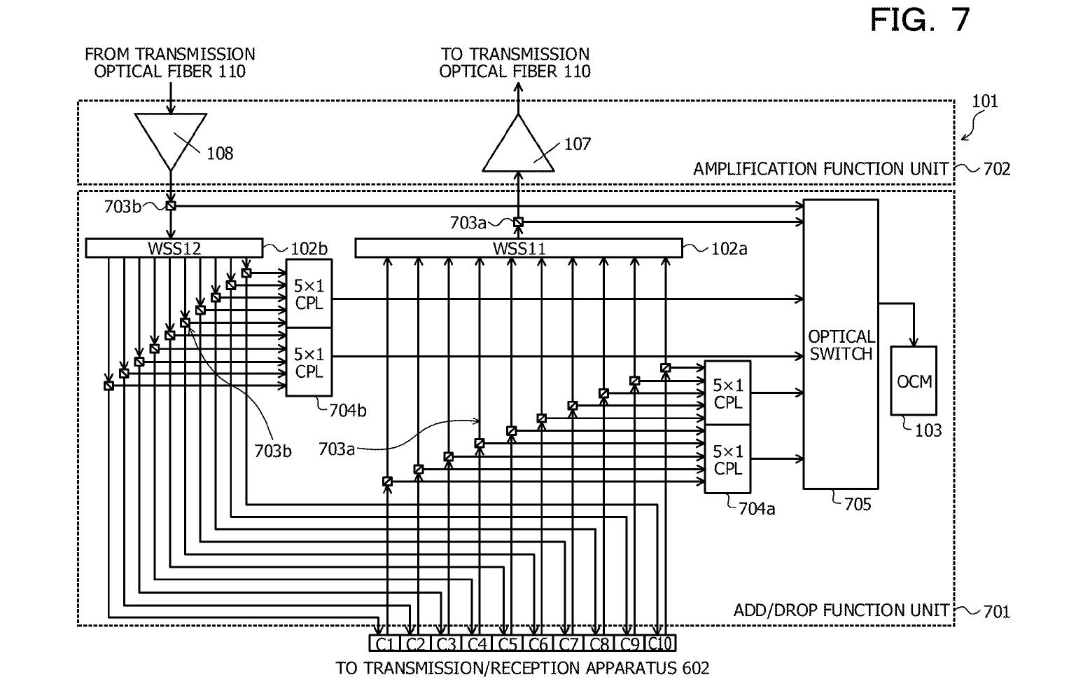

FIG. 7 is a diagram illustrating an example of a configuration of an OADM apparatus according to the first embodiment. That is, FIG. 7 is a diagram illustrating an example of an internal configuration of the OADM apparatuses 101 described above. Each of the OADM apparatuses 101 includes an add/drop function unit 701 and an amplification function unit 702.

The add/drop function unit 701 corresponds to the multi-input single-output WSS 102 which designates paths of the WDM signal for different channels of different wavelengths and controls attenuation amounts of individual light levels so as to output appropriate light levels. The WSS 102 includes a WSS 11 (102a) on a transmission side of an output toward the transmission optical fiber 110 and a WSS 12 (102b) on a reception side of an output of the WDM signal supplied from the direction of the transmission optical fiber 110 to a plurality of paths. The WSS 11 (102a) corresponds to the WSS 1 (102) of the OADM apparatus 1 (101a) in FIG. 1 and the WSS 12 (102b) corresponds to the WSS 2 (102) of the OADM apparatus 2 (101b) in FIG. 1.

A light level of an optical signal input to the WSS 11 (102a) is monitored by the OCM 103 for each channel. The OCM 103 detects light levels of the individual channels of an input of the WSS 11 (102a) through splitters 703a and optical couplers 704a by optical path switching successively performed by an optical switch 705. Similarly, the OCM 103 detects a light level of an output of the WDM signal of the WSS 102 through the optical switch 705.

The OCM 103 detects a light level of the WDM signal input to the WSS 12 (102b) through the optical switch 705. The OCM 103 also monitors light levels of the individual channels output from the WSS 12 (102b). The OCM 103 detects light levels of the individual channels through a splitter 703b and an optical coupler 704b by optical path switching successively performed by the optical switch 705 in individual channels of output of the WSS 11 (102a).

The light levels of the individual channels connected to the input port of the WSS 11 (102a) may be controlled to predetermined levels by the WSS 102 on the reception side of the other one of the OADM apparatuses 101 accommodated in the same OADM node 601 or the transmission/reception apparatus 602. In this case, assuming that the light levels of the individual channels in the input portions of the WSS 11 (102a) have been determined in advance, the monitoring function for monitoring the individual channels of the OCM 103 in the input portions of the WSS 11 (102a) illustrated in FIG. 7 may be omitted.

Here, it is preferable that a number of OCMs 103 corresponding to the number of directions (a plurality of channels) designated by the WSS 102 are provided so that the WDM signal branched by the OADM apparatuses 101 is subjected to the light level monitoring and the control for individual channels. However, if the OCMs 103 are provided in the individual directions, cost is increased in accordance with increase of a degree of freedom. To suppress the cost of the apparatus, as illustrated in FIG. 7, the add/drop function unit 701 includes the multi-channel optical switch 705 which switches connection between the paths of the WSS 102 and the OCM 103 and which successively monitors light levels of the individual paths for individual channels.

The amplification function unit 702 includes the post-amplifier 107 and the pre-amplifier 108. The post-amplifier 107 collectively amplifies the light levels of the WDM signal which is multiplexed and output by the add/drop function unit 701 before outputting the light levels to the optical transmission paths 110. The pre-amplifier 108 collectively amplifies the light levels of the WDM signal which has been supplied and attenuated through the transmission optical fiber 110. The WDM signal amplified by the pre-amplifier 108 is output to an OADM section in another direction or the transmission/reception apparatus 602 by the add/drop function unit 701 of the OADM node 601.

The WSS 11 (102a) controls signal light levels in the individual channels of the WDM signal to be supplied to the post-amplifier 107 connected to the transmission optical fiber 110. Specifically, the WSS 11 (102a) closes attenuation of unopened channels and opens attenuation of opened channels before supplying the WDM signal to the post-amplifier 107. The WSS 12 (102b) controls signal light levels in the individual channels of the WDM signal output from the pre-amplifier 108 connected to the optical transmission path 110 and outputs the signal light levels to another OADM apparatus 101 in the OADM node 601 or the transmission/reception apparatus 602.

In general optical transmission systems, a transmission light level deviation characteristic of a wavelength of a WDM signal which reaches the OADM apparatus 2 (101b in FIG. 1) from the OADM apparatus 1 (101a in FIG. 1) is not clear at a time of the opening for the WDM signal. Therefore, when signal communication is opened, a light level of an opened channel of the WDM signal is gradually increased to a certain level so that a reception apparatus on a downstream side is not damaged by an excessive reception light level on the downstream side of the optical transmission path 110. In a description of the general techniques below, components which are the same as those illustrated in the first embodiment are denoted by reference numerals which are the same as those illustrated in the first embodiment.

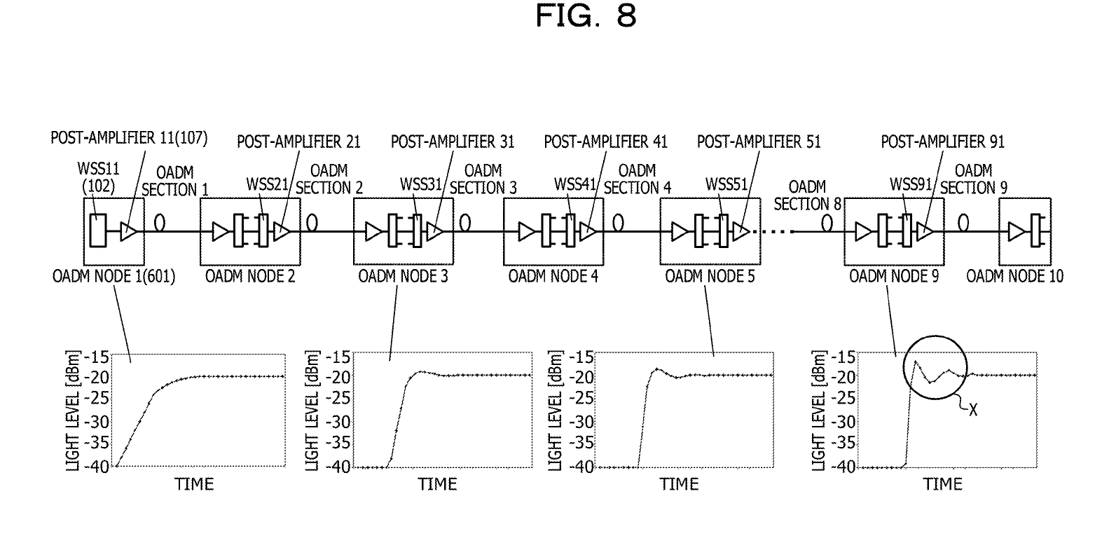

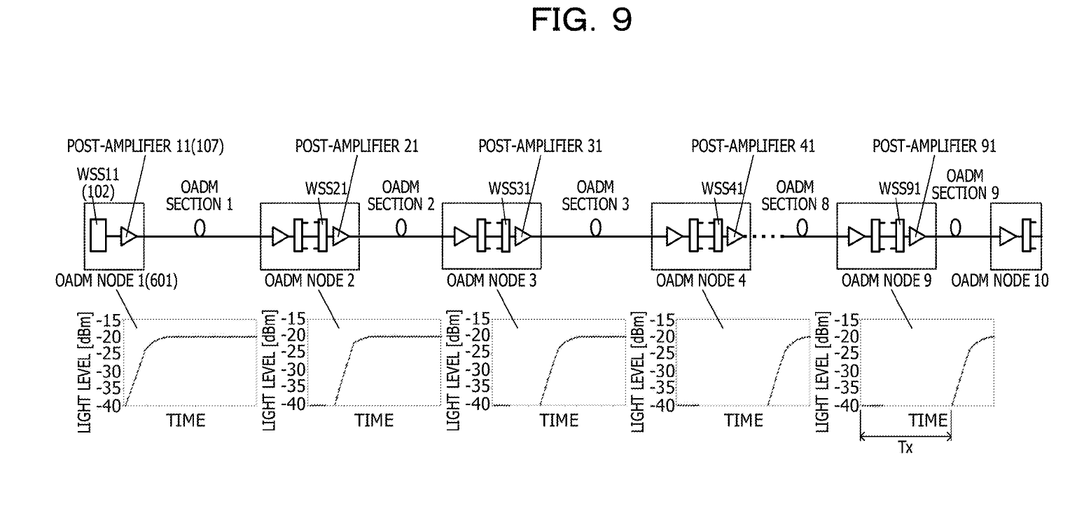

FIGS. 8 and 9 are diagrams illustrating a problem of opening control in the general optical transmission systems. A plurality of OADM nodes 601 included in an optical transmission system and light levels (axes of abscissae denote time and axes of ordinates denote light levels) in a number of the OADM nodes 601 are illustrated. The optical transmission system includes a plurality of OADM nodes 1 to 10 (601) on an optical transmission path 110 and OADM sections 1 to 9 are set between the adjacent OADM nodes 601.

In an example of FIG. 8, a case where all the OADM nodes 601 simultaneously perform opening control including attenuation control of the WSS 102 on the OADM sections 1 to 9 in parallel is illustrated. In this case, surge of light levels is increased in the OADM nodes 601 on a downstream side of the WDM signal. In the OADM node 9 (601) located in a most downstream side, surge of a light level is large (a portion X), and therefore, a long period of time is used for convergence.

In an example of FIG. 9, a case where successive opening is performed such that opening control is performed on an OADM node 601 on a downstream side in an OADM section after opening control of an OADM node 601 on an upstream side in the OADM section is completed is illustrated. In this case, the OADM nodes 1 to 9 (601) have long channel opening control periods for monitoring the light levels of the individual channels for individual input/output ports of the WSS 102.

In the opening control of the general techniques illustrated in FIG. 9, a transmission light level deviation characteristic of the WDM signal which reaches an adjacent one of the OADM nodes 601 (from the OADM apparatus 1 (101a) to the OADM apparatus 2 (101b)) relative to a wavelength is not clear. Therefore, the WSS controller 105 of the OADM apparatus 1 (101a) gradually controls an attenuation amount of a light level of a channel used for output from the WSS 1 (102) to the post-amplifier 1 (107) so that a certain light level is gradually obtained. For example, if an attenuation amount before opening of the channel b described above is 30 dB, a step of controlling an attenuation amount by a certain unit control amount is repeatedly performed before opening so that an attenuation amount of 10 dB is obtained.

Therefore, since the opening control is performed in the OADM node on the downstream side after the opening of the preceding OADM node 601 on the upstream side is completed, a starting time of the opening control delays on the downstream side. As a transmission distance of the plurality of OADM sections 1 to 9 of the optical transmission system becomes long, a period of time Tx until completion of opening of a channel of the WDM signal becomes long in an accumulation manner.

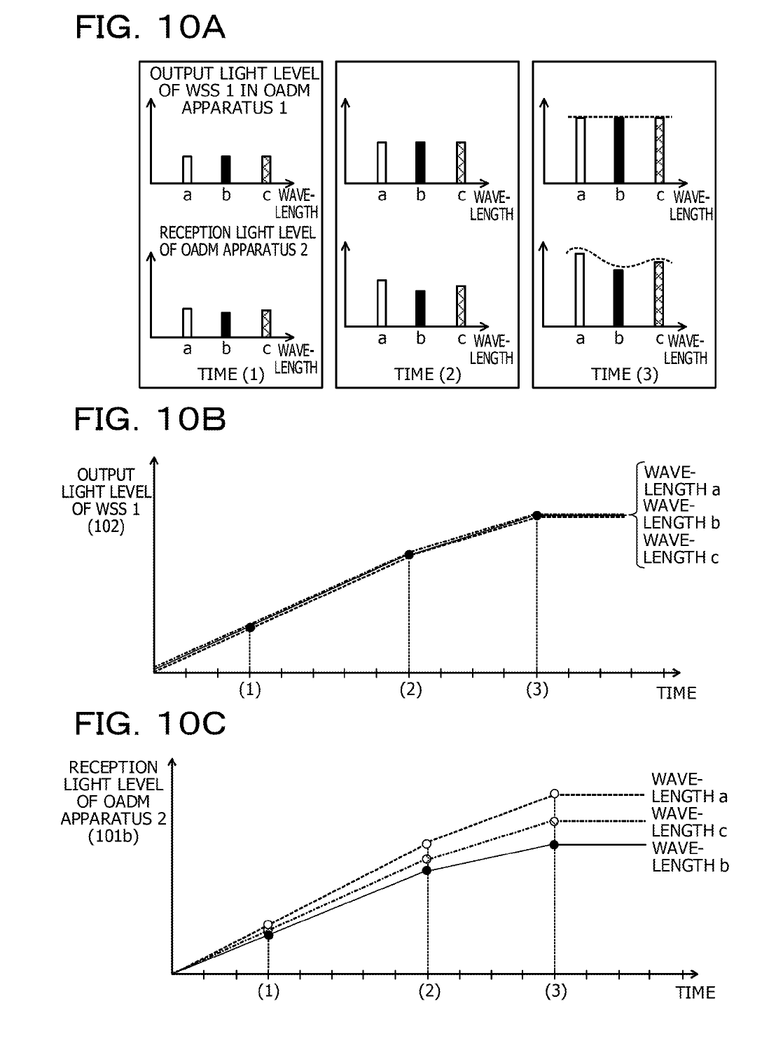

FIGS. 10A to 10C are diagrams illustrating a problem of the opening control in the general optical transmission systems. In FIGS. 10A to 10C, states of the light levels in the various units in the opening control using the attenuation amounts which are gradually changed in the general techniques illustrated with reference to FIG. 9 are illustrated. In FIG. 10A, output light levels of the WSS 1 (102) of the OADM apparatus 1 (101a) are illustrated, and axes of abscissae denote wavelengths in times (1) to (3) and axes of ordinates denote light levels. Even though output light levels which change in the different times are controlled to be the same in the different wavelengths in the OADM apparatus 1 (101a) on the transmission side of the WDM signal, reception light levels in the different wavelengths are different from each other (change) in the OADM apparatus 2 (101b) on the reception side.

In FIG. 1013, an axis of abscissae denotes times of wavelengths a to c of the WSS 1 (102) of the OADM apparatus 1 (101a) and an axis of ordinates denotes an output light level. In FIG. 10C, an axis of abscissae denotes times of wavelengths a to c of the OADM apparatus 2 (101b) and an axis of ordinates denotes a reception light level. Even if the output light levels of the wavelengths a to c are the same in the OADM apparatus 1 (101a) in FIG. 1013, light levels of the wavelengths a to c of the received WDM signal are different from one another in the OADM apparatus 2 (101b) as illustrated in FIG. 10C.

Therefore, as illustrated in FIGS. 10A to 10C, the OADM apparatus 2 (101b) monitors transmission light levels of the different wavelengths of the received WDM signal. Then the OADM apparatus 1 (101a) gradually controls an attenuation amount to be output from the WSS 1 (102) to the post-amplifier 107 while searching for a transmission light level characteristic in an OADM section between the OADM apparatus 1 (101a) and the OADM apparatus 2 (101b). Therefore, a long period of time is used to complete opening of a channel as described above.

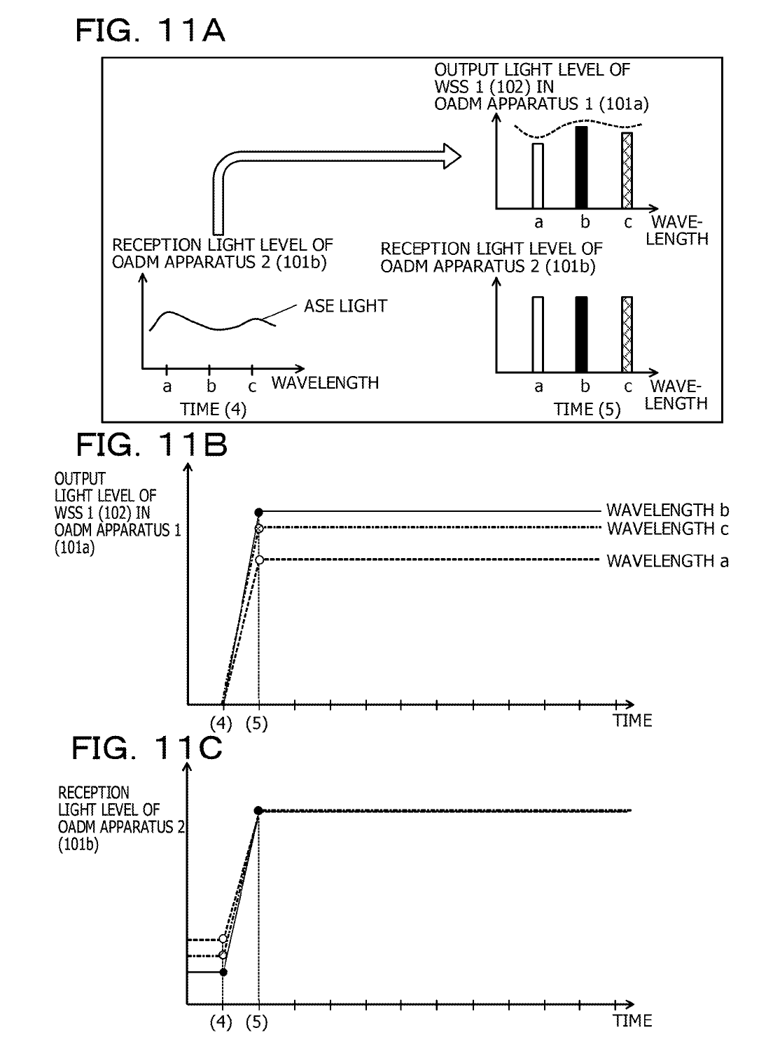

FIGS. 11A to 11C are diagrams illustrating a process of the opening control in the optical transmission systems according to the first embodiment. In FIG. 11A, axes of abscissae denote a wavelength and axes of ordinates denote a light level. In FIG. 11A, light level characteristics in the wavelengths a to c of the ASE light received by the OADM apparatus 2 (101b) and control of output light levels in the different wavelengths in the OADM apparatus 1 (101a) in a certain time (4) and reception light levels in the different wavelengths in the OADM apparatus 2 (101b) in a time (5) following the time (4) are illustrated.

In FIG. 11B, an axis of abscissae denotes times of the wavelengths a to c of the WSS 1 (102) of the OADM apparatus 1 (101a) after control of output light levels and an axis of ordinates denotes an output light level. The OADM apparatus 1 (101a) controls the light levels of the channels a to c so as to address transmission light level deviation of the ASE light and outputs the light levels. In FIG. 11C, an axis of abscissae denotes times of wavelengths a to c of the OADM apparatus 2 (101b) and an axis of ordinates denotes a reception light level.

According to the opening control illustrated in the first embodiment (refer to FIG. 5), the OADM apparatus 2 (101b) monitors the transmission light level of the ASE light in a wavelength of a channel which does not include the reached WDM signal. Then the OADM apparatus 1 (101a) controls an attenuation amount to be output from the WSS 1 (102) to the post-amplifier 1 (107) based on the transmission light level characteristic obtained between the OADM apparatus 1 (101a) and the OADM apparatus 2 (101b) which is a result of the monitoring. By the opening control described above, attenuation amounts may be quickly controlled to be certain attenuation amounts corresponding to the transmission light level deviation characteristics of the individual channels at a time of opening for the WDM signal, and the WDM signal may be quickly transmitted.

In the first embodiment, opening control may not be successively performed on sections from an upstream side even in an optical transmission system of a long distance in which OADM sections are cross-connected by a plurality of OADM nodes 601. Specifically, in the first embodiment, the transmission light level deviation characteristic of the WDM signal is recognized using the transmission light level deviation characteristic of the ASE light in each OADM section of the OADM apparatuses 101. In this way, a light level to be output to the post-amplifier 107 from the WSS 102 of the OADM apparatus 101 on the upstream side may be controlled to be an appropriate attenuation amount.

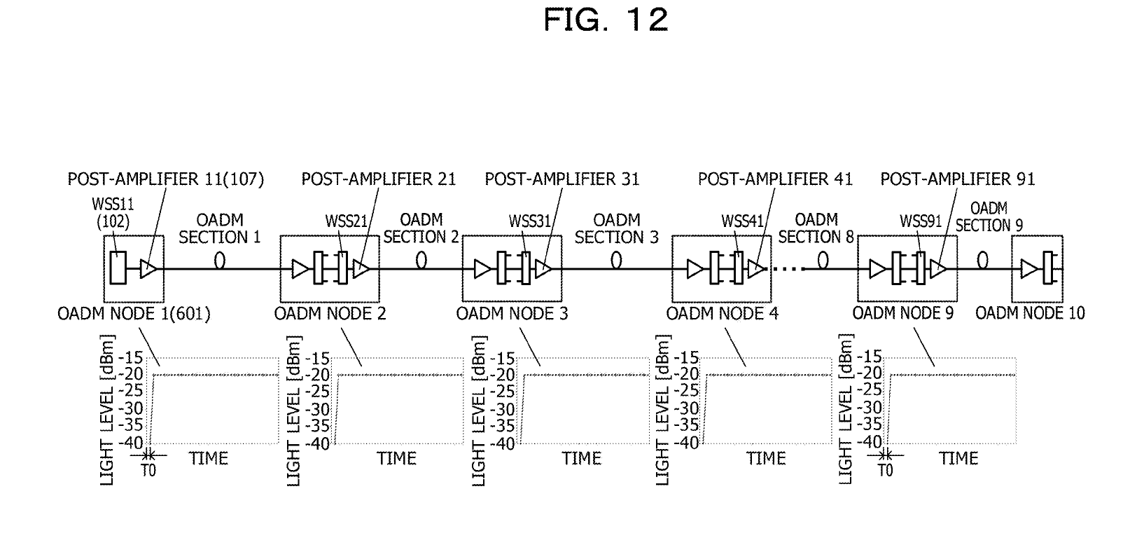

FIG. 12 is a diagram illustrating the opening control in the optical transmission system according to the first embodiment. A plurality of OADM nodes 601 included in the optical transmission system and light levels (axes of abscissae denote time and axes of ordinates denote light levels) in the individual OADM nodes 601 are illustrated. The optical transmission system includes a plurality of OADM nodes 1 to 10 (601) on an optical transmission path 110 and OADM sections 1 to 9 are set between the adjacent OADM nodes 601.

In the optical transmission system according to the first embodiment, each of the OADM nodes 2 to 10 on the downstream side includes the OCM 103 (refer to FIG. 1) which monitors light levels of different channels. In the OADM sections 1 to 9, the OADM node 601 on the downstream side transmits an OSC signal including level deviation information of the ASE light and level deviation information of the WDM signal (the transmission light) to the OADM node 601 on the upstream side which outputs the WDM signal.

In the opening control according to the first embodiment, the OADM node 601 (the OADM apparatus 101b) on the downstream side monitors the transmission light level of the ASE light in a wavelength of a channel which does not include the WDM signal in each of the OADM sections 1 to 9. Then, transmission light level characteristics in the individual OADM sections are evaluated, and the OADM node 601 (the OADM apparatus 101a) on the upstream side calculates attenuation amounts based on the transmission light level deviation characteristics of the individual channels in the OADM sections for the WSS 102 before opening for the WDM signal. Thereafter, the OADM node 601 (the OADM apparatus 101a) on the upstream side quickly performs control so as to obtain certain attenuation amounts corresponding to the transmission light level deviation characteristics at a time of the opening for the WDM signal.

In this way, according to the first embodiment, the OADM node 601 (the OADM apparatus 101a) on the upstream side in each of the OADM sections 1 to 9 performs the opening control on a channel using the transmission light level characteristics of the WDM signal obtained based on the transmission light level characteristics of the ASE light. Accordingly, the opening control (refer to FIG. 9) is not successively performed so as to successively clear the transmission light level characteristics of the WDM signal from an OADM section on a most upstream side. Then the each of the OADM nodes 601 (the OADM apparatus 101a) may quickly transmit the WDM signal by controlling certain attenuation amounts based on the transmission light level characteristics of the WDM signal in the corresponding one of the OADM sections 1 to 9.

As illustrated in FIG. 12, the OADM nodes 601 (the OADM apparatuses 101a) may simultaneously perform the opening control, and therefore, start times of the opening control are not delayed irrespective of the number of OADM sections. Even in a case of the optical transmission system of a long distance which uses the plurality of OADM sections 1 to 9 for transmission, a time TO until completion of opening of channels of the WDM signal in all the OADM sections 1 to 9 corresponds to only one OADM section (the OADM section 1, for example).

The CPU 201 (the WSS controller 105) of the OADM apparatus 1 (101a) performs control of increasing an attenuation amount of the WSS 1 (102) which performs output in a direction of the transmission optical fiber 110 for an unopened channel which has not been opened (refer to FIG. 5). By this, a path of the output from the WSS 102 to the post-amplifier 107 corresponding to the unopened channel is blocked. It is assumed here that, in an optical transmission system in which a plurality of OADM nodes 601 are cross-connected to one another as illustrated in FIG. 12, ASE light generated in an OADM section on an upstream side in a channel which is not to be opened is output to an OADM section on a downstream side.

In this case, when transmission light levels of the ASE light are measured in the different OADM sections, the ASE light generated in the OADM section on the upstream side is accumulated on the ASE light in the OADM section on the downstream side since the ASE light generated in the OADM section on the upstream side is supplied to the OADM section on the downstream side. By this accumulation, a difference between a transmission light level deviation characteristic of the measured ASE light and a transmission light level deviation characteristic of the ASE light in the OADM section is generated, and light level deviation of the WDM signal is generated at a time of opening due to an error of a calculated attenuation value corresponding to the transmission light level deviation characteristic of the WDM signal.

On the other hand, according to the first embodiment, the path of the output from the WSS 1 (102) to the post-amplifier 107 is blocked by increasing the attenuation amount of the WSS 1 (102) which is output in the direction of the transmission optical fiber 110 in the channel which is not to be opened. Accordingly, the accumulation of the ASE light caused by output of the ASE light generated in the OADM section on the upstream side to the OADM section on the downstream side may be suppressed. In addition, the measurement of the transmission light level deviation characteristics of the ASE light in the different OADM sections may be accurately performed.

### Second Embodiment

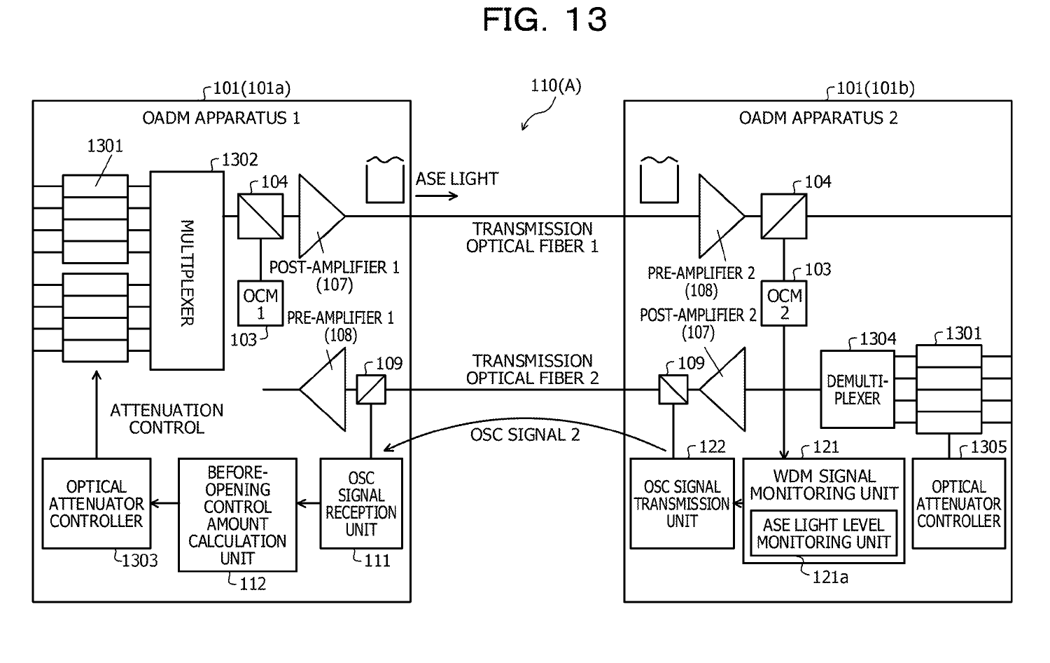

FIG. 13 is a diagram illustrating an example of a configuration of an optical transmission system including an optical transmission apparatus according to a second embodiment. Components which are the same as those of the first embodiment (FIG. 1) are denoted by reference numerals which are the same as those of the first embodiment.

The OADM apparatuses 101 of the first embodiment (refer to FIG.
1) includes the multiple-input single-output WSS 102 as the wavelength selection unit. In the second embodiment, a plurality of single-input single-output variable optical attenuators 1301 capable of controlling an attenuation amount are disposed instead of the WSS 102 as illustrated in FIG. 13, and a multiplexer 1302 performs multiplexing. Instead of the WSS controller 105 of the first embodiment (FIG. 1), an optical attenuator controller 1303 which controls the variable optical attenuators 1301 is provided. An OADM apparatus 2 (101b) includes a demultiplexer 1304 which demultiplexes outputs of the variable optical attenuators 1301 and an optical attenuator controller 1305 which controls attenuation amounts of the variable optical attenuators 1301.

Other configurations illustrated in FIG. 13 are the same as those of the first embodiment (FIG. 1), and a before-opening control amount calculation unit 112 calculates an attenuation amount of an optical attenuator in accordance with transmission light level deviation information of ASE light in a wavelength of a channel which does not include a WDM signal. Then the optical attenuator controller 1303 performs control such that an attenuation amount calculated by the before-opening control amount calculation unit 112 is obtained before opening of an unopened channel (the channel b described above).

As described in the second embodiment, as with the first embodiment, a certain attenuation amount corresponding to the transmission light level deviation characteristic may be quickly controlled before opening for a WDM signal even in a configuration in which a plurality of variable optical attenuators are used instead of a WSS. The opening control may be quickly started irrespective of the number of OADM sections, and a WDM signal may be quickly transmitted irrespective of the number of OADM sections.

### Third Embodiment

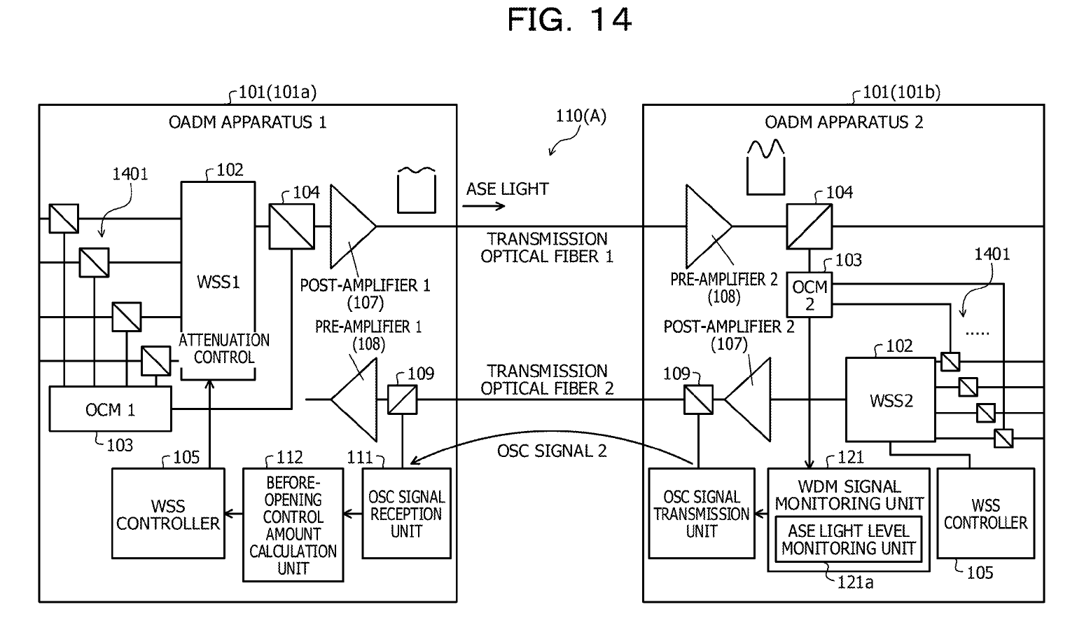

FIG. 14 is a diagram illustrating an example of a configuration of an optical transmission system including an optical transmission apparatus according to a third embodiment. In the third embodiment, an OCM 103 monitors input light intensities of different channels in input portions of WSSs (102) of OADM apparatuses 1 and 2 (101a and 101b). Splitters 1401 are provided for the input portions to which outputs of channels which have been input to a WSS 1 (102) of the OADM apparatus 1 (101a) are supplied, and an OCM 1 (103) serving as an input light monitoring unit monitors the splitters 1401. Similarly, splitters 1401 are provided for input portions to which outputs of channels which have been input to a WSS 2 (102) of the OADM apparatus 2 (101b) are supplied, and an OCM 2 (103) monitors the splitters 1401.

In this way, in a case where an excessive light level is input to the WSS 1 (102) of the OADM apparatus 1 (101a), transmission of the excessive light level to the OADM apparatus 2 (101b) through a post-amplifier 1 (107) and a transmission optical fiber 110 may be suppressed. Accordingly, an adverse effect, such as damage to a reception apparatus, may be suppressed.

In a configuration example of FIG. 14, it is assumed that, before a channel a is opened, a certain light level P_IN_TGT(a) of an input of the WSS 1 (102) of the OADM apparatus 1 (101a) is −10 dBm. Furthermore, it is assumed that a calculated attenuation value ATT(a) of the channel a which is obtained by a before-opening control amount calculation unit 112 and which is to be output from the WSS 1 (102) to the post-amplifier 1 (107) is 11 dB. In this case, an output light level P_OUT(a) of the channel a to be output from the WSS1 (102) to the post-amplifier 1 (107) is −21 dBm.

Here, in a case where an input light level of the channel a in an input of the WSS 1 (102) of the OADM apparatus 1 (101a) is −7 dBm, an attenuation amount of the WSS 1 (102) is controlled so that a calculated attenuation amount ATT(a) of 11 dB is obtained. In this case, an output light level P_OUT(a) of the channel a to be output from the WSS1 (102) to the post-amplifier 1 (107) is −18 dBm, and an excessive light level is transmitted to the OADM apparatus 2 (101b) on a downstream side. To suppress the transmission of the excessive light level, the WSS controller 105 performs attenuation control such that an attenuation control value ATT_CONT(a) of the WSS 1 (102) is equal to ATT(a)+(P_IN(a)−P_IN_TGT(a)).

By this attenuation control, an attenuation amount of the WSS 1 (102) is controlled to be 14 dB (ATT_CONT(a)=14 dB). In this case, an output light level P_OUT(a) of the channel a to be output from the WSS1 (102) to the post-amplifier 1 (107) is −21 dBm.

According to the third embodiment, attenuation control is performed so that an intensity difference obtained by subtracting certain intensity from an input light intensity is added to an attenuation amount of the WSS 102 when the input light intensity exceeds a predetermined intensity. Accordingly, excessive attenuation amounts in different channels, that is, different opened ports of the WSS 102, are suppressed so that appropriate attenuation amounts are obtained. Although the WSS 102 is used in the configuration example of FIG. 14, the present technique is applicable to a configuration including a plurality of variable optical attenuators 1301 as illustrated in the second embodiment (FIG. 13).

The OCM 1 (103) monitors input light intensities of different channels in input portions of the WSS 1 (102) of the OADM apparatus 1 (101a). When a light intensity of an input of the WSS 1 (102) of the OADM apparatus 1 (101a) in a channel to be opened is smaller than a predetermined intensity, the CPU 201 (the WSS controller 105) does not perform opening control on the channel and determines that the channel is not to be opened. In this case, as described above, a path from the WSS to the post-amplifier is blocked by increasing an attenuation amount of the WSS 1 (102) to be output in a direction of a transmission optical fiber at the time of opening control (refer to FIG. 5).

Accordingly, the accumulation of the ASE light caused by output of the ASE light generated in the OADM section on the upstream side to the OADM section on the downstream side may be suppressed. In addition, the measurement of the transmission light level deviation characteristics of the ASE light in the different OADM sections may be accurately performed.

### Fourth Embodiment

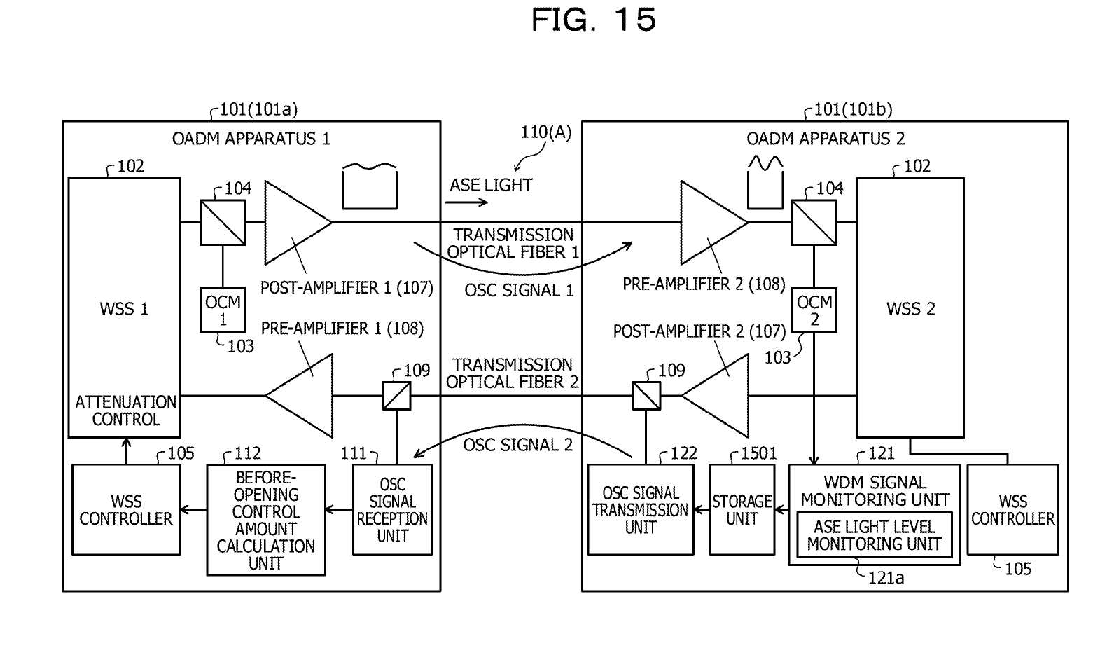

FIG. 15 is a diagram illustrating an example of a configuration of an optical transmission system including an optical transmission apparatuses according to a fourth embodiment. In the fourth embodiment, an OADM apparatus 2 (101b) includes a storage unit 1501 which stores ASE light level deviation information monitored by an OCM 2 (103). Other configurations in FIG. 15 are the same as those of the first embodiment (refer to FIG. 1).

When a channel a of a WDM signal is opened, the OADM apparatus 2 (101b) may not monitor an ASE light level since the WDM signal is included in a wavelength of the channel a instead of the ASE light. Therefore, an ASE light level monitoring unit 121a stores the ASE light level of the channel a before opening in the storage unit 1501 as ASE light level deviation information (intensity distribution) of all channels including the ASE light levels of other unopened channels. When the ASE light level deviation information is continuously or periodically stored in the storage unit 1501 before opening, for example, accurate ASE light level deviation information which is lately obtained may be used at a time of the opening.

An ASE light level monitoring unit 121a of the OADM apparatus 2 (101b) may read the ASE light level deviation information of a wavelength of the channel a from the storage unit 1501 and transmit the ASE light level deviation information to the OADM apparatus 1 (101a) at a time of the opening of the channel a of the WDM signal.

The OADM apparatus 2 (101b) may further include a transmission optical fiber failure detection unit (not illustrated) which detects disconnection of a transmission optical fiber connected from the OADM apparatus 1 to the OADM apparatus 2.

The transmission optical fiber failure detection unit stops a process of storing the ASE light level deviation information of different channels monitored by the OCM 2 (103) of the OADM apparatus 2 (101b) when detecting disconnection of the transmission optical fiber 1 (110). When the transmission optical fiber 1 (110) connected from the OADM apparatus 1 (101a) to the OADM apparatus 2 (101b) is disconnected, ASE light generated in the post-amplifier 1 (107) of the OADM apparatus 1 (101a) is blocked before the ASE light reaches the OADM apparatus 2 (101b).

When the transmission optical fiber 1 (110) is not disconnected, the ASE light level deviation characteristic monitored by the OCM 2 (103) of the OADM apparatus 2 (101b) is obtained by adding ASE light generated in optical amplifiers 107 and 108 of the OADM apparatuses 1 and 2 (101a and 101b) to each other. However, if the transmission optical fiber 1 (110) connected from the OADM apparatus 1 (101a) to the OADM apparatus 2 (101b) is disconnected, ASE light generated in the post-amplifier 1 (107) of the OADM apparatus 1 (101a) is blocked. Therefore, ASE light is generated only in a pre-amplifier 2 (108) of the OADM apparatus 2 (101b), and therefore, an ASE light level deviation characteristic which is different from that before the disconnection is obtained.

Thereafter, when the disconnection of the transmission optical fiber 1 (110) between the OADM apparatus 1 (101a) and the OADM apparatus 2 (101b) is recovered and the transmission optical fiber 1 (110) is connected again, a condition for opening for a WDM signal is satisfied. Here, the before-opening control amount calculation unit 112 of the OADM apparatus 1 (101a) performs attenuation control for output from the WSS 1 (102) to the post-amplifier 107 based on the ASE light level deviation information supplied from the OADM apparatus 2 (101b).

Accordingly, when the transmission optical fiber failure detection unit detects the disconnection of the transmission optical fiber 1 (110), the updating process of storing the ASE light level deviation information which is being monitored in the storage unit 1501 is stopped in the OADM apparatus 2 (101b). By this stop, the storage unit 1501 stores the ASE light level deviation information detected immediately before the disconnection of the transmission optical fiber 1 (110).

When the transmission optical fiber failure detection unit detects recovery of all the disconnection of the transmission optical fiber 1 (110) between the OADM apparatuses 1 and 2 (101a and 101b), a condition for opening for the WDM signal between the OADM apparatuses 1 and 2 (101a and 101b) is satisfied. Since the opening condition is satisfied, the ASE light level deviation information in the unopened channel monitored by the OCM 2 (103) of the OADM apparatus 2 (101b) is stored in the storage unit 1501 again. In this way, the ASE light level deviation information corresponding to the transmission optical characteristic between the OADM apparatus 1 (101a) and the OADM apparatus 2 (101b) after the reconnection may be store in the storage unit 1501 as update.

The OADM apparatus 2 (101b) may include a shutdown detection unit which detects stop (shutdown) of the amplification control performed by one of the optical amplifiers 107 and 108 which output the WDM signal from the OADM apparatus 1 (101a) to the OADM apparatus 101b.

In this case, an amplification control state of the post-amplifier 1 (107) of the OADM apparatus 1 (101a) is transmitted to the OADM apparatus 2 (101b) using an ISC signal 1 to be transmitted from the OADM apparatus 1 (101a) to the OADM apparatus 2 (101b). The ASE light level monitoring unit 121a of the OADM apparatus 2 (101b) stores the ASE light level deviation information of the different channels monitored by the OCM 2 (103) in the storage unit 1501 based on the amplification control state of the post-amplifier 1 (107) and the amplification control state of the pre-amplifier 2 (108). The amplification control states indicate whether shutdown is performed, for example.

Then, it is assumed that the shutdown detection unit detects shutdown of the post-amplifier 1 (107) or the pre-amplifier 2 (108). In this case, the ASE light level monitoring unit 121a stops the updating process of storing the ASE light level deviation information of the different ASE light level deviation information of the different channels monitored by the OCM 2 (103) in the storage unit 1501. When one of the optical amplifiers 107 and 108 which output the WDM signal from the OADM apparatus 1 (101a) to the OADM apparatus 2 (101b) is shut down, ASE light to reach the OCM 2 (103) of the OADM apparatus 2 (101b) is blocked. In this case, an ASE light level deviation characteristic which is different from that before the shutdown is obtained.

After recovery from the shutdown, the amplification control is started by the optical amplifiers 107 and 108 which output the WDM signal from the OADM apparatus 1 (101a) to the OADM apparatus 2 (101b) which is a condition for opening for the WDM signal. Since the opening condition is satisfied, the before-opening control amount calculation unit 112 of the OADM apparatus 1 (101a) performs attenuation control for output from the WSS 1 (102) to the post-amplifier 1 (107) based on the ASE light level deviation information.

Accordingly, when the shutdown detection unit detects shutdown of the optical amplifiers 107 and 108 in an OADM section, the ASE light level monitoring unit 121a stops the updating process of storing monitored ASE light level deviation information in the storage unit 1501. By this, the ASE light level deviation information obtained before the detection of the shutdown is stored in the storage unit 1501.

Then it is assumed that the shutdown detection unit detects start of the amplification control in all the optical amplifiers 107 and 108 in the OADM section from the OADM apparatus 1 (101a) to the OADM apparatus 2 (101b). In this case, a condition for opening for the WDM signal to be transmitted from the OADM apparatus 1 (101a) to the OADM apparatus 2 (101b) is satisfied. Then the ASE light level monitoring unit 121a of the OADM apparatus 2 (101b) restarts the storing of the ASE light level deviation information of an unopened channel monitored by the OCM 2 (103) in the storage unit 1501. By this, the ASE light level deviation information corresponding to the transmission light characteristics between the OADM apparatus 1 (101a) and the OADM apparatus 2 (101b) is stored in the storage unit 1501 as update.

According to the fourth embodiment, the ASE light level deviation information of the channel before opening may be stored in the storage unit 1501 in an update available manner. Then the ASE light level deviation information to be used in the OADM apparatus 1 (101a) may be transmitted at the time of opening of the channel. When the transmission optical fiber 110 is disconnected or when one of the post-amplifier 1 (107) and the pre-amplifier 2 (108) which are optical amplifiers in the OADM section is shut down, update of the ASE light level deviation information is stopped. In this way, accuracy of the ASE light level deviation information stored in the storage unit 1501 may be maintained.

### Fifth Embodiment

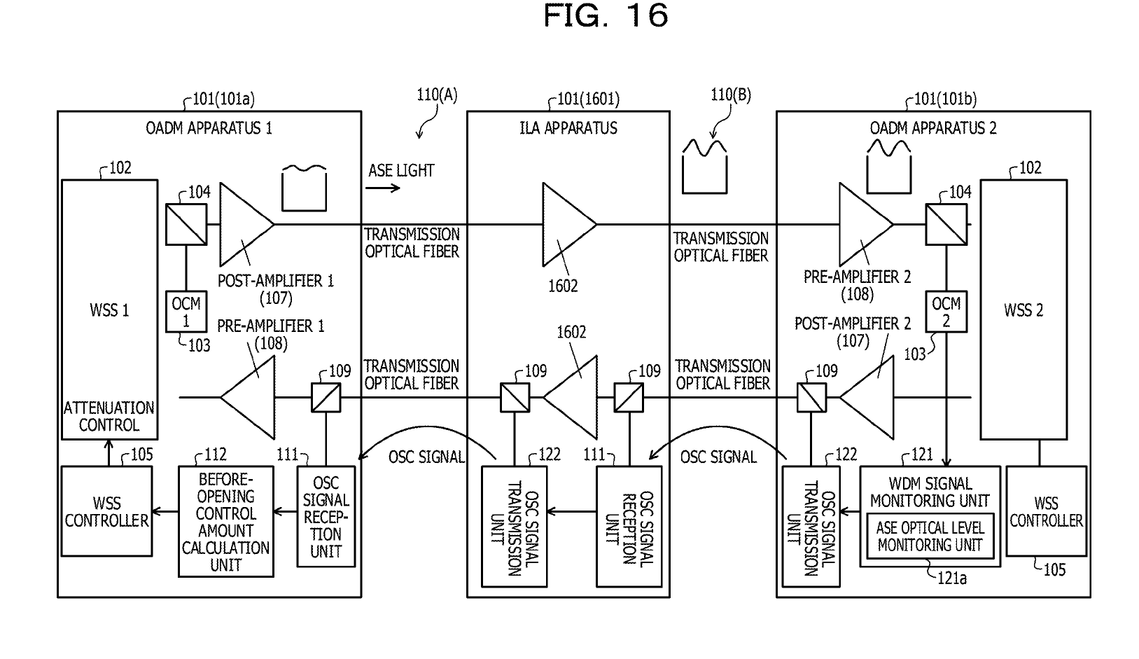

FIG. 16 is a diagram illustrating an example of a configuration of an optical transmission system including optical transmission apparatuses according to a fifth embodiment. In the first to fourth embodiments described above, the optical transmission system including the OADM apparatus 1 (101a) and the OADM apparatus 2 (101b) is described. As illustrated in FIG. 16, the present technique is applicable to a configuration in which an in-line amplifier (ILA) apparatus 1601 including an optical amplifier 1602 which amplifies optical power of a WDM signal is disposed between an OADM apparatus 1 (101a) and an OADM apparatus 2 (101b).

The ILA apparatus 1601 performs optical amplification on transmission light of WDM in OADM sections A and B between the OADM apparatuses 1 and 2 (101a and 101b). In the fifth embodiment, the OADM apparatus 2 (101b) includes an OSC signal reception unit 111 and an OSC signal transmission unit 122.

The OADM apparatus 2 (101b) obtains ASE light level deviation information of optical amplifiers 107, 108, and 1602 disposed between the OADM apparatus 1 (101a) and the ILA apparatus 1601, between the ILA apparatus 1601 and the OADM apparatus 2 (101b). The ILA apparatus 1601 relays the ASE light level deviation information transmitted from the OADM apparatus 2 (101b) to the OSC signal reception unit 111 and the OSC signal transmission unit 122 and transmits the ASE light level deviation information to the OADM apparatus 1 (101a).

In this way, even in the optical transmission system including the ILA apparatus in an OADM section, operation effects the same as those in the first to fourth embodiments may be obtained.

### Sixth Embodiment

A sixth embodiment addresses a case where, in the optical transmission system according to any one of the first to fifth embodiments described above, light level deviation characteristics corresponding to wavelengths of ASE light generated in the optical amplifiers 107 and 108 (and 1602) are different from each other depending on amplification control of the optical amplifiers 107 and 108 (and 1602). A before-opening control amount calculation unit 112 of the OADM apparatus 1 (101a) performs correction in accordance with amplification control information of the optical amplifiers 107 and 108 (and 1602) on a calculated attenuation amount to be output from a WSS 1 (102) to a post-amplifier 1 (107).

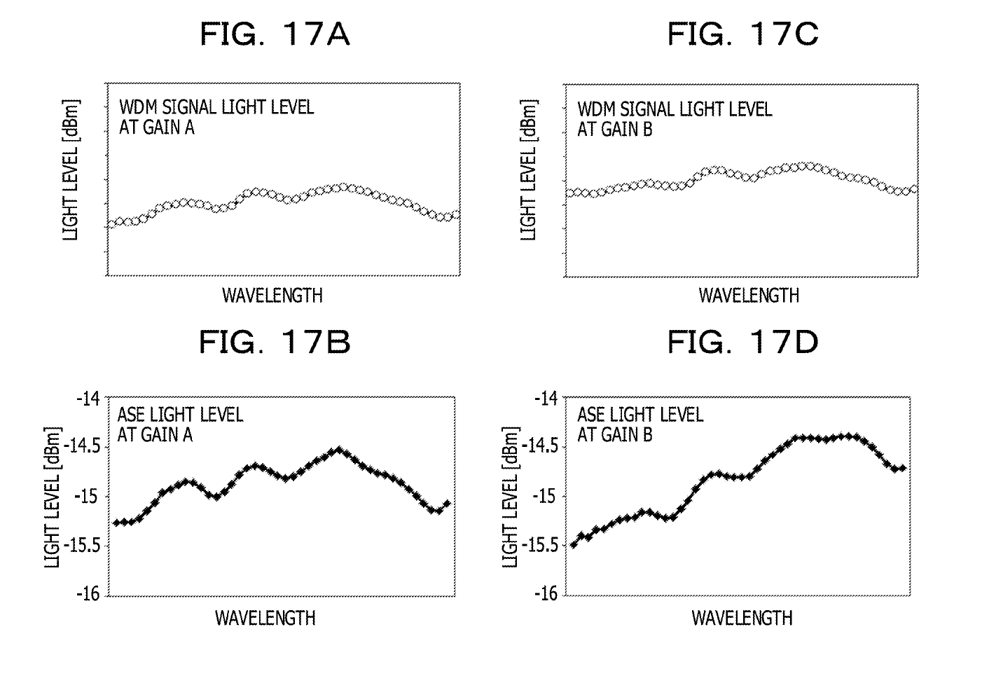

FIGS. 17A to 17D are diagrams illustrating a process corresponding to light level deviation for each gain in the optical transmission system according to the sixth embodiment. In FIGS. 17A and 17B, a WDM signal light level and an ASE light level (axes of abscissae denote a wavelength and axes of ordinates denote a light level) at a gain A obtained when optical amplification control is performed using a pre-amplifier 2 (108) of the OADM apparatus 2 (101b) according to the first embodiment (refer to FIG. 1), for example, are illustrated. In FIGS. 17C and 17D, a WDM signal light level and an ASE light level (axes of abscissae denote a wavelength and axes of ordinates denote a light level) at a gain B obtained when optical amplification control is performed using a pre-amplifier 2 (108) of the OADM apparatus 2 (101b) are illustrated.

For example, when operation is performed at the gain B, the WDM signal light level has a uniform characteristic relative to a wavelength whereas the ASE light level is low in a short wavelength and high in a long wavelength.

The before-opening control amount calculation unit 112 of the OADM apparatus 1 (101a) calculates an attenuation amount of a channel b to be output from the WSS 1 (102) to the post-amplifier 1 (107) in accordance with Expression (2) described in the first embodiment: ATT(b)=10 dB+ΔP_ASE(b)×α(b). Thereafter, in the sixth embodiment, in a case where the light level deviation characteristic of the ASE light represents inclination relative to the light level deviation characteristic of the WDM signal in accordance with control information of the optical amplifiers 107 and 108, that is, a gain G, for example, the before-opening control amount calculation unit 112 calculates a value α(b) in accordance with Expression (3) below.

α(b)=β×G×(b/N) (3)

Note that “β” denotes a coefficient determined by an optical amplifier and “N” denotes the maximum number of channels accommodated in the optical transmission system.

By this, the OADM apparatus 1 (101a) may obtain an accurate attenuation amount of the WSS 1 (102) in accordance with change of the light level deviation characteristic of the ASE light based on change of the gains of the optical amplifiers 107 and 108 (and 1602).

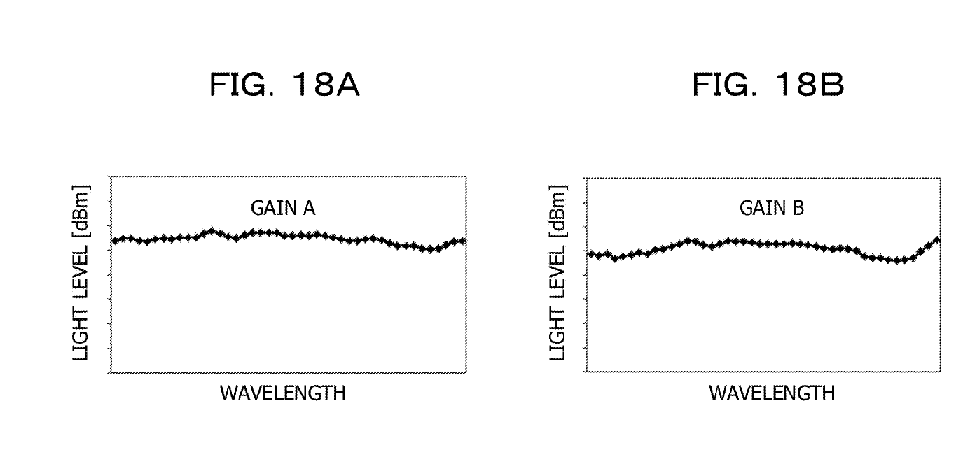

FIGS. 18A and 18B are diagrams illustrating light levels of transmission light in a process corresponding to the light level deviation for each gain in the optical transmission apparatus according to the sixth embodiment. FIG. 18A illustrates a transmission light level characteristic of the WDM signal obtained when the pre-amplifier 2 (108) of the OADM apparatus 2 (101b) operates at the gain A. FIG. 18B illustrates a transmission light level characteristic of the WDM signal obtained when the pre-amplifier 2 (108) of the OADM apparatus 2 (101b) operates at the gain B.

When the pre-amplifier 2 (108) of the OADM apparatus 2 (101b) operates in accordance with a change from the gain A to the gain B, the before-opening control amount calculation unit 112 performs correction on an attenuation amount in accordance with Expression (3). As illustrated in FIGS. 18A and 18B, even when the gain A is changed to the gain B, the transmission light level of the WDM signal may be flat relative to a wavelength. In this way, the before-opening control amount calculation unit 112 may perform control such that a certain attenuation amount is obtained based on transmission light level characteristics of different channels and opening for the WDM signal may be quickly performed.

In the foregoing embodiments, when a signal of the optical transmission system is to be transmitted, an OADM apparatus 2 disposed on a downstream side in an OADM section measures an ASE light level at a wavelength of an unopened channel using ASE light of an optical amplifier and transmits ASE light level deviation information to an OADM apparatus 1 disposed on an upstream side. In this way, the OADM apparatus 1 may determine amplification characteristics of different channels of the optical amplifier included in the OADM apparatus 1 and loss characteristics of optical power, that is, transmission characteristics of the WDM signal based on the ASE light level deviation information. Similarly, even in a case where an optical amplifier, such as an optical relaying apparatus, is additionally disposed in the OADM section, the OADM apparatus 1 may determine amplification characteristics of different channels of the optical amplifier included in the OADM apparatus 1 and loss characteristics of optical power, that is, transmission characteristics of the WDM signal based on the ASE light level deviation information. Then the OADM apparatus 1 controls the attenuation amount of the WDM signal to be transmitted to a certain level based on a transmission characteristic. Here, an opening time for the WDM signal may be reduced by quickly controlling the attenuation amount.

Even in an optical transmission system in which long-distance transmission is realized by cross-connecting a plurality of OADM sections of a plurality of OADM nodes, ASE light level deviation information is calculated for each OADM section and an OADM apparatus on an upstream side performs attenuation control based on a transmission characteristic. By this, opening for a WDM signal may be quickly performed without successively performing general opening control based on a notification indicating a channel opening state between a plurality of OADM nodes.

The optical transmission methods described in the foregoing embodiments may be realized when control programs provided in advance are executed by a computer (a processor, such as a CPU) of a target apparatus (an optical transmission apparatus). The control programs may be recorded in a computer readable recording medium, such as a magnetic disk, an optical disc, or a universal serial bus (USB) flash memory, and executed when the control programs are read by the computer. The control programs may be distributed through a network, such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical transmission apparatus, comprising:
a wavelength selection switch configured to:
receive signal light, and
attenuate power of the received signal light;
an optical amplifier coupled to the wavelength selection switch and configured to
optically amplify the attenuated signal light; and
a processor configured to control the wavelength selection switch to attenuate power of signal light which passes a channel which is newly set by an attenuation amount based on information on light levels of spontaneous emission light generated by the optical amplifier.

2. The optical transmission apparatus according to claim 1, wherein the processor is configured to:
receive deviation information indicating light levels of the spontaneous emission light of individual wavelengths obtained by the optical transmission apparatus on a downstream side which is disposed adjacent to the optical transmission apparatus as the information on light levels;
set an attenuation amount of the signal light which passes the channel and which is correlated with the deviation information; and
increase the signal light in which the attenuation amount has been set to a predetermined light level by controlling the attenuation amount after the channel is opened.

3. The optical transmission apparatus according to claim 2,
wherein the processor is configured to receive a value of deviation of the light levels relative to an average of the spontaneous emission light of an unopened channel as the deviation information of the spontaneous emission light.

4. The optical transmission apparatus according to claim 1,
wherein the processor is configured to attenuate the signal light input to a multi-input single-output wavelength selection switch.

5. The optical transmission apparatus according to claim 1,
wherein the processor is configured to attenuate the signal light to be input in variable optical attenuators provided for a plurality of channels.

6. The optical transmission apparatus according to claim 1, wherein the processor is configured to:
monitor light intensity of the input signal light; and
add an intensity difference obtained by subtracting a predetermined light intensity from the light intensity of the signal light when the light intensity of the signal light exceeds a predetermined intensity to the attenuation amount.

7. The optical transmission apparatus according to claim 6, wherein the processor is configured to:
block a path of output to the optical amplifier when the light intensity of the monitored signal light is less than a predetermined intensity; and
execute the opening control when the light intensity of the signal light satisfies the predetermined intensity.

8. The optical transmission apparatus according to claim 1, wherein the processor is configured to set an attenuation amount of the signal light based on the information on the light level of the spontaneous emission light in a state in which transmission of the signal light in an unopened channel is blocked.

9. The optical transmission apparatus according to claim 1,
wherein the processor is configured to attenuate power of the signal light which passes the channel by an attenuation amount of the signal light based on amplification control information of another optical amplifier disposed in a section between the optical amplifier of the optical transmission apparatus and another optical transmission apparatus on a downstream side which is disposed adjacent to the optical transmission apparatus and intensity distribution of the spontaneous emission light relative to a wavelength in the section.

10. An optical transmission apparatus, comprising:
a first optical amplifier configured to receive signal light and perform optical amplification on the signal light;
an optical monitor configured to detect a light level of spontaneous emission light generated by a second optical amplifier included in another optical transmission apparatus on an upstream side which is disposed adjacent to the optical transmission apparatus and a light level of spontaneous emission light generated by a third optical amplifier disposed in a section between the optical transmission apparatus and the other optical transmission apparatus; and
a processor configured to transmit information on the light levels of the spontaneous emission light detected by the optical monitor to the other optical transmission apparatus.

11. The optical transmission apparatus according to claim 10,
wherein the processor is configured to transmit deviation information indicating light levels of the spontaneous emission light of different wavelengths as information on the light levels.

12. The optical transmission apparatus according to claim 11,
wherein the processor is configured to calculate values of deviation of the light levels relative to an average of the spontaneous emission light of unopened channels as the deviation information of the spontaneous emission light.

13. The optical transmission apparatus according to claim 10, further comprising a memory configured to store intensity distribution relative to a wavelength of the spontaneous emission light,
wherein the processor is configured to:
store intensity of the spontaneous emission light in the wavelength before opening in the memory;
read the intensity at a time of the opening; and
calculate the deviation information.

14. The optical transmission apparatus according to claim 13, wherein the processor is configured to:
detect disconnection of an optical transmission path in the section; and
update intensity distribution of the spontaneous emission light of a wavelength in which optical signals are not multiplexed which is stored in the memory when the optical transmission path is recovered after the disconnection.

15. The optical transmission apparatus according to claim 12, wherein the processor is configured to:
detect interruption of amplification control of one of the optical amplifiers disposed in the section; and
update intensity distribution of the spontaneous emission light of a wavelength in which optical signals are not multiplexed which is stored in the memory when the optical amplifier is recovered after the interruption.

16. An optical transmission method executed by an optical transmission apparatus, the optical transmission method comprising:
receive signal light using a processor;
attenuate power of the received signal light;
optically amplify the attenuated signal light using an optical amplifier; and
attenuate, using the processor, power of signal light which passes a channel which is newly set by an attenuation amount based on information on a light level of spontaneous emission light generated by the optical amplifier.
